(19) United States
(12) Patent Application Publication
(10) Pub. No.: US 2006/0254887 A1
(43) Pub. Date: Nov. 16, 2006

(54) Sanitary conveyor

(76) Inventors: Larry Aubry, Hampshire, IL (US); Joe Zabala, Algonquin, IL (US)

Correspondence Address: David A. Gottardo;Attorney at Law, Suite 01, 918 South Kenilworth Avenue, Oak Park, IL, 60304-1913, US

(21) Appl. No.: 11/430,417

(22) Filed: May 9, 2006

Related U.S. Application Data
(60) Provisional application No. 60/680,193, filed on May 11, 2005.
(60) Provisional application No. 60/729,867, filed on Oct. 24, 2005.

(51) Int. Cl. B65G 21/08

(52) U.S. Cl. 198/860.3

(57) ABSTRACT

This invention relates generally to conveyors, particularly to a sanitary conveyor adapted for use in production applications requiring usually frequent, periodic cleaning procedures in strict compliance with sanitary standards. The conveyor comprises a frame which comprises a conveyor bed supported by a plurality of legs or a suspension system, and at least one rotatable roller supported by the frame. At least one endless belt is in contact with the at least one roller of the conveyor, the at least one belt defining both an upper portion (conveying run) and lower portion (return run), with the upper portion (conveying run) supported by the conveyor bed. At least one longitudinal shield is movably attached to the frame and is movable between at least opened and closed positions, with the at least one longitudinal shield located laterally of at least the conveyor bed when the shield is in the closed position. At least one catch pan may be removably supported by the frame of the conveyor below the lower portion or return run of the at least one endless belt to catch any wayward particulate matter and/or residual drips that may fall from the lower portion or return run of the belt. At least one shelf may be defined on the at least one movable shield for removably supporting removable conveyor bed components during cleaning operations.

### CROSS REFERENCE TO RELATED APPLICATIONS

This application claims priority to U.S. Provisional Patent Application Ser. No. 60/680,193 filed on May 11, 2005, and to Ser. No. 60/729,867 filed on Oct. 24, 2005.

### TECHNICAL FIELD OF THE INVENTION

This invention relates generally to conveyors, particularly to sanitary conveyors adapted for use in applications requiring usually frequent, periodic cleaning procedures in strict compliance with sanitary standards.

### BACKGROUND OF THE INVENTION

Belt-type conveyors are often used in the processing and assembly of food products, pharmaceuticals, electronics and the like. With regard to the processing and assembly of food products, sanitation is a primary consideration and conveyors must be maintained in a clean and hygienic condition to meet government sanitary standards. Food conveyors are typically comprised of multiple components that must be cleaned (i.e. by steam, hot water or chemicals) periodically in compliance with government regulations and industry standards. However, because of traditional design, access to many of the internal components of a typical conveyor is difficult, thus requiring a disassembly of the conveyor itself to expose such components to the required cleaning processes.

For example, many conveyors present in the art have a complex framework that includes multiple rollers and lengthwise, rigidly-mounted side walls which support a series of transverse beams having wear surfaces located thereon. The conveyor belt is moved and/or supported by the rollers while a conveying portion of the belt is supported by and moves against the wear surfaces. Access openings are thus typically provided throughout the length of the rigidly-mounted side walls to allow access to the internal components of the conveyor (i.e. transverse beams, wear strips and rollers, etc.) during the cleaning processes.

Personnel conducting such cleaning operations typically direct a stream of the high-pressure steam, hot water and/or cleaning fluids into and through the access openings of the side walls to clean the internal components. However, the access provided by such openings is usually limited, thus requiring a disassembly of the side walls and/or belt from the conveyor. Such disassembly is time consuming and labor intensive, resulting in productivity losses during food production. Also, the removal of a belt from the conveyor during cleaning procedures presents additional handling issues. Because conveyor belts are typically very long and cumbersome, their removal from a given conveyor-exposes the belt to potential contaminants i.e., contact with cleaning personnel and/or the floor. Where such disassembly is not undertaken, perhaps as a time-saving measure, the inaccessible components remain unclean and prone to contamination.

The disassembly of the conveyor's many components during cleaning procedures, such as the side walls, rollers and wears surfaces, may be difficult where these components are assembled with complex fasteners (i.e. nuts and bolts) requiring the use of tools. The presence of these fasteners during such disassembly thus requires considerable down-time, again resulting in productivity losses during food production. Furthermore, the presence of complex fasters on the conveyor establishes areas where particulate matter and/or residues from conveyed food products may collect, thus making such areas prone to contamination if not properly cleaned.

Many conveyors present in the art are also constructed of a framework that includes many extended, horizontal surfaces. Such horizontal surfaces are undesirable because they too establish areas where particulate matter and/or residues can collect, thus creating areas prone to contamination. The horizontal surfaces are also undesirable because they also promote the collection of cleaning fluids during cleaning processes, thus hindering the desired draining of such fluids from the conveyor.

Also, the framework of many conveyors present in the art is constructed of hollow members or components. Such members or components are undesirable because they may harbor contaminants therein if the walls or welds of the respective component are cracked or includes penetrations there-through. To indicate the presence of such cracks or penetrations, hollow members or components in a sanitary setting may be filled with an indicating fluid that would leak from within to disclose any penetrations within the walls or welds of the component. However, filling hollow members or components with an indicating fluid presents obvious disadvantages in a sanitary food production setting where leaked indicating fluids may contaminate the food products themselves.

Many conveyors present in the art include one or more removable trays located beneath the belt for catching any particulate matter or drips that may fall from the belt during food processing operations. However, present conveyors utilizing such trays do not include any restraining mechanism that prevents the tray from falling to the floor during cleaning operations, thus making the trays susceptible to contamination. Also, present conveyors provide no means for positioning the tray in a location that readily allows cleaning personnel to wipe or sweep the tray clean of particulate matter or drips. Instead, cleaning personnel typically remove the tray from the conveyor and walk it to a waste receptacle to wipe or sweep it free of such matter and/or drips, thus exposing the tray to contamination. Furthermore, present conveyors do not provide any means for securing the tray in a non-horizontal position during sanitizing operations. Cleaning personnel instead sanitize the tray while it is located below the belt of the conveyor (in a horizontal position), thus resulting in an undesirable collection of cleaning fluids thereon.

Thus, there is a need for a conveyor that allows for a ready access to its internal components during cleaning processes. The conveyor should be of a simplified construction and have a clean design to preferably minimize both the use of fasteners (and associated tools) and the presence of horizontal surfaces, thus minimizing areas where particulate matter, residues and/or cleaning fluids may collect. The components of the conveyor should preferably be of a solid cross section to minimize hollow areas that may harbor contaminants and/or bacteria. The conveyor should also restrain any tray located thereon from falling to the floor during cleaning operations, allow for an adjustable positioning of the tray to facilitate the ready wiping or sweeping of particulate matter and/or drips there-from while attached to the conveyor, and provide a means for securing the tray in a non-horizontal position to facilitate proper sanitization. The present invention meets these desires.

### SUMMARY OF THE INVENTION

This invention relates generally to conveyors, particularly to a sanitary conveyor adapted for use in production applications requiring usually frequent, periodic cleaning procedures in strict compliance with sanitary standards. In one embodiment, the conveyor comprises a frame which comprises a conveyor bed supported by a plurality of legs, and at least one rotatable roller supported by the frame. At least one endless belt is in contact with the at least one roller of the conveyor, the at least one belt defining both an upper portion (conveying run) and lower portion (return run), with the upper portion (conveying run) supported by the conveyor bed. At least one longitudinal shield is movably attached to the frame and is movable between at least opened and closed positions, with the at least one longitudinal shield located laterally of at least the conveyor bed when the shield is in the closed position.

In one embodiment of the conveyor, the conveyor bed of the frame, supported by the plurality of legs, comprises a plurality of longitudinal rails having at least a sloped upper surface and fixably connected to a plurality of cross members, with the cross members supporting a plurality of wear strips. In another embodiment of the conveyor, the conveyor bed comprises a plurality of longitudinal rails fixably connected to a plurality of end members. The bed further comprises a plurality of intermediate members supporting a plurality of wear strips located substantially between the end members, with the longitudinal rails supporting the intermediate members and having at least a sloped upper surface. The sloped upper surface of the longitudinal rails in both embodiments minimizes the presence of horizontal surfaces and the resultant collection of particulate matter, residues or fluids thereon.

The plurality of legs disposed along the conveyor to support the conveyor bed are preferably disposed in paired relationship about at least two of the cross members or end members such that a given cross or end member is located between and fixably connected to a pair of the plurality of legs. In other embodiments of the invention, at least two of the cross members or end members of the conveyor bed are each located substantially between a pair of connectors of the frame disposed proximal to the upper ends of the legs. A through bore is defined in each connector such that the pair of connectors can operably engage the opposing axle ends of a drive or idler roller of the conveyor. An access opening is preferably also defined in each connector to allow cleaning access to the exposed cylindrical body of the roller having ends engaged with the bore of each connector.

At least one leg brace may be fixably connected between paired legs and below a given cross member or end member to secure the legs of a given pair together for added lateral support. Optionally, at least one strut may be fixably connected between legs located on a common side of the conveyor for added longitudinal support. Similar to the longitudinal rails, both the leg braces and the optional struts have at least a sloped upper surface to minimize the presence of horizontal surfaces and the resultant collection of particulate matter, residues or fluids thereon.

The at least one rotatable roller, supported by the frame and in contact with the at least one endless belt, may be rotatably driven by a motor or may be a non-driven, idler roller. Any quantity of the at least one roller may be located on the conveyor as well, with such quantity comprising only one roller, typically used with a “bull-nosed” conveyor, two rollers, or any quantity of driven and/or non-driven rollers. Such rollers of the at least one rotatable roller, although preferably removably supported by the frame, may be fixably supported by the frame as well. The at least one roller, in one embodiment, is comprised of at least one substantially cylindrical body of solid material rotatably mounted in concentric relation to an axle. The roller preferably utilizes a pin on each side of a given cylindrical body to prevent the body from translating along the axle. However, it is understood that the at least one roller may be unitary as well. The axle has opposing ends that protrude outwardly of the at least one cylindrical body. At least one pair of receivers is thus defined within the frame and is adapted for operable engagement with the opposing ends of the axle. In one embodiment of the conveyor, each receiver comprises a downwardly-directed, elongated recess defined in each leg of the frame and adapted for removable, sliding engagement with an axle end. In other embodiments, each receiver is defined in a respective receiver flange of the frame, connected to the frame via either the legs or longitudinal rails of the conveyor.

The at least one endless belt in contact with the at least one roller defines an upper portion or conveying run and a lower portion or return run, with the upper portion or conveying run supported by the conveyor bed. The upper portion or conveying run of the at least one endless belt passes over and is supported by the wear strips of the conveyor bed while the lower portion or return run is disposed below the wear strips, cross members or end and intermediate members, and longitudinal rails of the bed.

At least one catch pan may be removably supported by the frame of the conveyor below the lower portion or return run of the at least one endless belt to catch any wayward particulate matter and/or residual drips that may fall from the lower portion or return run of the belt. The at least one catch pan is thus removable from the frame of the conveyor during cleaning operations so that cleaning personnel can remove the particulate matter and/or drips deposited thereon by the at least one belt and thereafter clean and sanitize the pan.

A retaining means removably retains the at least one catch pan in a substantially horizontal orientation in relation to the frame while located in a plurality of positions on the frame. An adjustment means defines a plurality of positional relationships between the catch pan and the frame, to include a “catch position,” wherein the pan is under the lower portion of the at least one belt to catch any wayward particulate matter and/or residual drips that may fall from the belt during food processing operations, and a “pre-cleaning position,” wherein the pan is located in a position that allows cleaning personnel can readily wipe or sweep particulate matter there-from and into a receptacle without having to completely remove the pan from the frame of the conveyor.

An engagement means removably engages the at least one catch pan to the frame in a non-horizontal, “sanitize” position, after the pan has been removed from its location on the frame below the lower portion of the at least one endless belt, to promote the draining of cleaning fluids there-from during cleaning or sanitization operations. At least one hood may be removably located between paired legs of the plurality of legs, below the associated cross member or end member and having at least a sloped upper surface that overlaps the at least one catch pan, to deflect any particulate matter or drips onto the pan that may fall between leg pairs from the endless belt.

The at least one longitudinal shield, movably attached to the frame of the conveyor, is movable between at least opened and closed positions and is located laterally of at least the conveyor bed when the shield is in the closed position. The movable attachment of the at least one longitudinal shield to the frame comprises a pivot means and a securement means. The pivot means enables a pivoting and translating movement of a given shield between opened, closed and secured positions on the frame while the securement means releasably retains the shield in the closed position to the frame.

The at least one shield comprises a substantially longitudinal panel having upper and lower edges and defining inner and outer surfaces. The vertical distance between the upper and lower edges of each shield is predetermined such that a given shield is located laterally of at least the conveyor bed when in the closed position. The at least one shield may also have an increased vertical distance between its respective upper and lower edges such that the shield is located laterally of both the upper and lower portions (conveying and return runs) of the at least one endless belt, and optionally of the at least one roller as well, to prevent any interference with these components by personnel using the conveyor, thus preventing possible injury to these personnel. Also when in the closed position, the upper edge of the at least one shield may be located upwardly of the upper portion of the at least one belt by a predetermined distance to function as a guide-way that prevents conveyed food products from falling from the outer edges of the belt's upper portion during production operations. For embodiments of the conveyor utilizing connectors as part of the frame, the at least one shield preferably defines a longitudinal distance such that the shield, when in the closed position, is located laterally of the access opening defined in each connector.

At least one shelf may be defined on the at least one movable shield for removably supporting at least one of the removable wear strips, and optionally at least one of the intermediate members during cleaning operations. The at least one shelf is preferably defined on the inner surface of the shield such that the shelf is readily accessible when the shield is in the opened position. During cleaning operations, the at least one longitudinal shield is moved to an opened position to make the at least one shelf, located on a given shield's inner surface, accessible. The endless belt is thereafter removed from the conveyor bed and the wear strips are removed from the cross members or intermediate members and thereafter placed on the least one shelf to undergo the cleaning operations. If intermediate members are utilized on the conveyor, the members are removed from the longitudinal rails of the bed and also placed on the at least one shelf.

The respective pivot means of the at least one shield preferably comprise a plurality of slots defined proximal to the lower edge of the shields and a respective plurality of lower pins located on the frame, with the slots and lower pins adapted for mating engagement with one another. The slots, preferably having a substantially vertical orientation in relation to the at least one shield when the shield is in the closed position, are in mating engagement with the respective lower pins such that each pin projects longitudinally through each respective slot. The elongated shape of the slots allows for both an upwardly and downwardly traversing movement and a rotational movement of the slots about the pins.

The traversing movement allows the at least one shield, while in a substantially vertical and closed position, to traverse upwardly and downwardly in relation to the frame in securing the shield to the frame while the rotational movement allows the upper edge of the given shield to rotate outwardly away from the frame about 180 degrees from the substantially vertical and closed position to the fully opened position. When in the fully opened position, the shield is again preferably in a substantially vertical position, but inverted or “upside-down” from the closed position such that the upper edge of the shield is now directed downwardly (i.e. towards the floor) and the inner surface of each shield is directed outwardly. When the at least one shield is in its opened position, it is no longer located laterally of at least the conveyor bed, thus allowing a ready exposure of the bed's components and endless belt to steam, hot water, chemical or pressure-wash cleaning processes. In another embodiment of the invention, the movable attachment of the at least one shield to the frame may also comprise a removable attachment as well to allow for a removal of the at least one shield from the frame during cleaning procedures.

In one embodiment of the conveyor, the securement means of the at least one shield comprises a plurality of openings defined proximal to the shield's upper edge and a plurality of upper pins located on the frame, with the openings and upper pins adapted for removable mating engagement with one another. The openings, preferably having a substantially horizontal orientation in relation to the at least one shield when the shield is in the closed position, are in removable mating engagement with the upper pins when in the closed position such that each pin projects upwardly through each respective opening. In another embodiment, the plurality of openings is defined on the frame while the plurality of upper pins is located proximal to the upper edge of the at least one shield, with the openings and upper pins again adapted for removable mating engagement with one another. The upper pins each have a substantially horizontal orientation in relation to the at least one shield, when the shield is in the closed position, and downwardly-directed ends. Thus, when the at least one shield is in the closed position, the pins are in removable mating engagement with the respective openings such that each pin projects longitudinally through each respective opening, with the downwardly directed pin ends removably securing the shield to the frame. In both embodiments, the pivot means of the at least one shield works in association with the respective securement means to position the shield such that each securement means releasably retains the shield in the closed position to the frame. Other embodiments of the pivot means may comprise at least one hinge or other mechanism understood in the art located at the lower edge of the at least one shield and attached to the frame, while other embodiments of the securement means may comprise at least one latch or other mechanism understood in the art located on the shield for engagement with the frame. It is noted that for the protection of personnel using the conveyor, the at least one shield may further comprise a locking means such that the locking means locks the shield in at least the closed position.

With regard to the at least one shield, it is understood that any number of the at least one longitudinal shield may be utilized on the conveyor in any combination. It is further understood that that additional embodiments of the conveyor may comprise a frame comprising a conveyor bed supported by a suspension system in place of the plurality of legs. In these embodiments, the at least one rotatable roller is again supported by the frame, with the least one endless belt in contact with the at least one roller of the conveyor. The at least one belt again defines both upper and lower portions and, with the upper portion (conveying run) supported by the conveyor bed. At least one longitudinal shield is again movably attached to the frame and is movable between at least opened and closed positions, with the at least one longitudinal shield located laterally of at least the conveyor bed when the shield is in the closed position. The suspension system may support embodiments of the conveyor bed having cross members supporting the wear strips, or embodiments of the bed having intermediate members supporting the wears strips located substantially between the end members. The at least one shield may again define at least one shelf for removably supporting at least one wear strip and/or intermediate member during cleaning procedures, while the frame may again removably support hoods, and further removably support at least one catch pan between “catch,” “pre-cleaning” and “sanitize” positions.

With regard to the foregoing components of the conveyor 10 utilizing a suspension system, it is noted that their operation and function, where applicable, is as described for embodiments of the conveyor utilizing a plurality of legs. All of the components of the frame, at least one catch pan, hoods, as well as the at least one longitudinal shield and shelves, are preferably comprised of stainless steel and preferably have a solid cross section for ease of cleaning. Although components of solid cross section are preferred, the components may nonetheless have a hollow cross section (i.e. where necessary as a cost or weight-saving measure). Where applicable, the components are securably attached to one another with continuous welds of a quality that are cleanable, sanitizable, and resist the harboring of contaminants. A use of fasteners such as screws, bolts, nuts and washers to attach these components to one another is undesirable because such fasters establish areas where particulate matter and/or residues from conveyed food products may collect, thus making the areas prone to contamination. However, it is understood that such common fasteners, although undesirable, may nonetheless be used to attach or fasten any of the conveyor's components to one another.

### BRIEF DESCRIPTION OF THE DRAWINGS

FIG. 1 is a perspective assembly view of the components of one embodiment of the conveyor 10;

FIG. 2 is an end view of the conveyor 10 of FIG. 1;

FIG. 2A is an end view of an alternate embodiment of the conveyor 10 having additional longitudinal rails 24 and belts 19 arranged in parallel relation to one another;

FIG. 2B is an end view of an alternate embodiment of the conveyor 10 illustrating longitudinal rails 24 having a sloped upper surface 28 defined by a round cross section of the rails;

FIG. 3 is a side view of a conveyor 10 of extended length having additional longitudinal rails arranged in series relation to one another and connected to additional cross members 26 (the at least one longitudinal shield 22 omitted for clarity);

FIG. 4 is a partial perspective view illustrating the seat 30 of a cross member 26 in relation to a wear strip 34;

FIG. 4A is a perspective view of a conveyor 10 illustrating an alternate embodiment of the frame 12 and conveyor bed 14;

FIG. 4B is a perspective view of an intermediate member 120 and wear strip 34 of the alternate embodiment of the conveyor bed 14 of FIG. 4A;

FIG. 4C is a side view of an alternate embodiment of the conveyor 10 illustrating the locations of end members 115 in relation to the legs 16;

FIG. 5 is a detailed view of one embodiment of the at least one roller 18 of the conveyor 10;

FIG. 6 is a perspective assembly view of the frame 12 of the conveyor 10 in relation to the at least one catch pan 50 and hoods 84, also illustrating alternate locations of the openings 100a and 100b and the upper pins 102a and 102b located on the legs 16 (the at least one endless belt 19 and shield 22 omitted for clarity);

FIG. 6A is a perspective partial view of one embodiment of the engagement means 80 for removably engaging the catch pan 50 to the frame in a non-horizontal position;

FIG. 6B is a perspective partial view of an alternate embodiment of the engagement means 80 for removably engaging the catch pan 50 to the frame in a non-horizontal position;

FIG. 7 is a right side view of the conveyor 10 of FIG. 1 having the longitudinal shield 22a located in the closed position (the at least one endless belt 19 omitted for clarity);

FIG. 7A is a detailed view of one embodiment of the pivot means 88 for movably attaching the at least one shield 22 to the frame of the conveyor;

FIG. 8 is a left side view of the conveyor 10 of FIG. 1 having the longitudinal shield 22b located in the closed position (the at least one endless belt 19 omitted for clarity);

FIG. 8A is a perspective view of an embodiment of the conveyor 10 illustrating the securing means 90a and 90b in relation to the shields 22a and 22b and the end members 115, and also illustrating the shelves 160 located on the at least one shield;

FIG. 8B is a perspective view of the conveyor 10 illustrating an alternate embodiment of the securing means 90a and 90b in relation to the shields 22a and 22b and the connectors 135, and also illustrating the shelves 160 located on the at least one shield holding at least one wear strip 34;

FIG. 8C is a perspective view of the conveyor illustrating connectors 135 of the frame 12 utilized with cross members 26 (the at least one shield omitted for clarity);

FIG. 9 is an end view of the conveyor 10 of FIG. 1 showing the operation of the longitudinal shield 22a in the disengaged, closed and fully opened positions;

FIG. 10 is a view of the conveyor 10 of FIG. 7 showing the longitudinal shield 22a in the fully opened position (the at least one endless belt 19 omitted for clarity);

FIG. 10A is an end view of the conveyor 10 of FIG. 8B showing the operation of the longitudinal shields 22a and 22b respectively in the engaged and closed, and fully opened positions;

FIG. 11 is a side view of the conveyor 10 showing the hinge 104 and latch 106 as alternate embodiments of the pivot means and securement means, respectively, and also showing the locking means 190 (the at least one endless belt 19 omitted for clarity);

FIG. 11A is a detailed view of one embodiment of the locking means 190 for locking the at least one shield 22 in the closed position;

FIG. 12A is a perspective view of a conveyor 10 having two longitudinal shields 22a located on only one side of the conveyor (the at least one endless belt 19 and wear strips 34 omitted for clarity);

FIG. 12B is a perspective view a conveyor 10 having two longitudinal shields 22a located on only one side of the conveyor and one longitudinal shield 22b located on an opposite side of the conveyor, and also showing alternate locations of the upper pins 102a and 102b (the at least one endless belt 19 and wear strips 34 omitted for clarity);

FIG. 13A is a perspective view of one embodiment of the conveyor 10 having at least one longitudinal shield 22 and also having the conveyor bed 14 supported by the tension supports 210 of a suspension system 205; and

FIG. 13B is a perspective view of another embodiment of the conveyor 10 having hoods 84 and at least one catch pan 50, and also having the conveyor bed 14 supported by the tension supports 210 of a suspension system 205 (the at least one shield 22 omitted for clarity).

### DESCRIPTION OF THE PREFERRED EMBODIMENTS

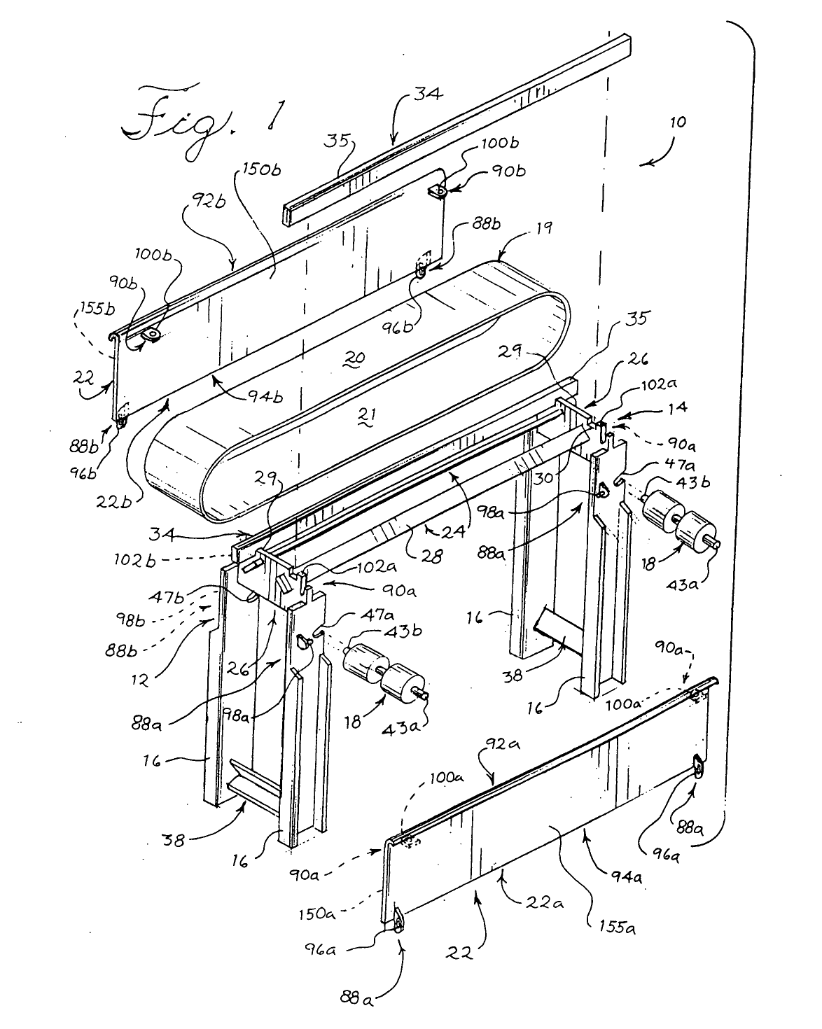

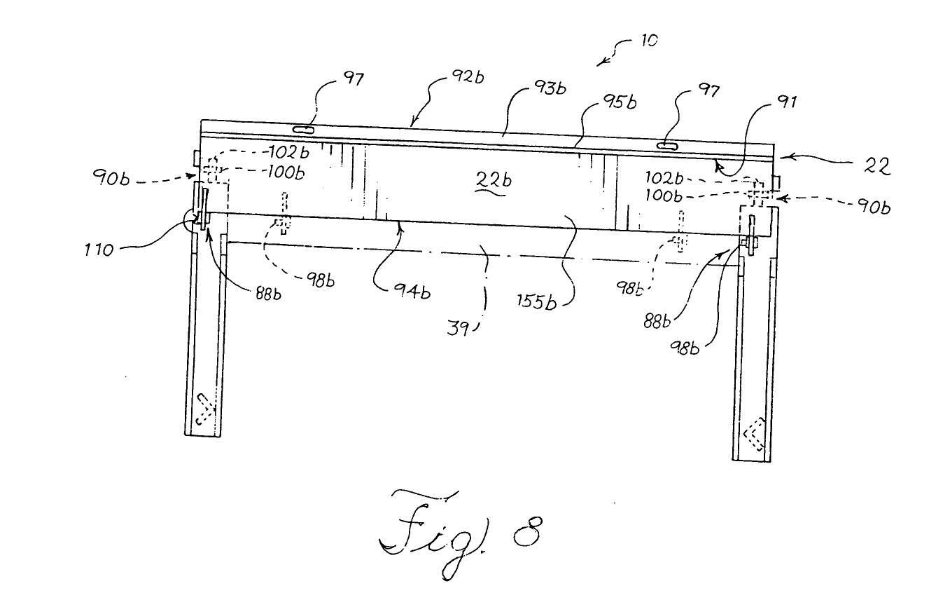

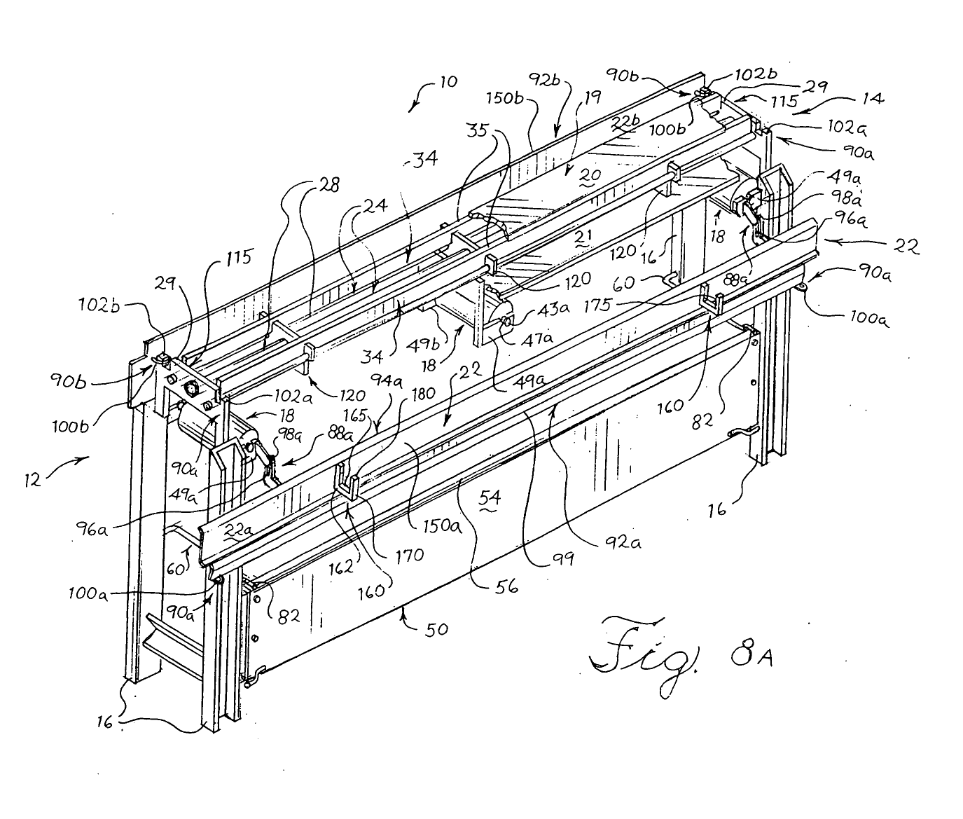

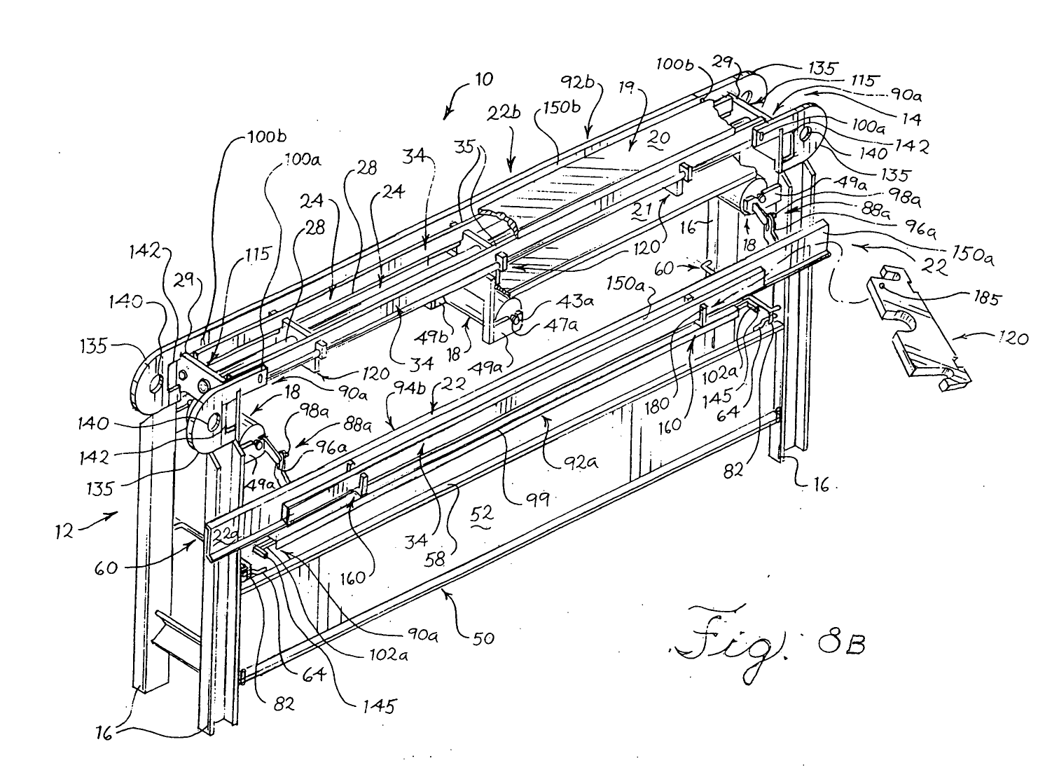

This invention relates generally to conveyors, particularly to a sanitary conveyor adapted for use in production applications requiring usually frequent, periodic cleaning procedures in strict compliance with sanitary standards. Referring initially to FIGS. 1, 2, 8A, 8B and 8C, conveyor 10 in one embodiment comprises a frame 12 comprising a conveyor bed 14 supported by a plurality of legs 16, and at least one rotatable roller 18 supported by the frame. At least one endless belt 19 is in contact with the at least one roller 18 of the conveyor 10, the at least one belt defining both an upper portion (conveying run) 20 and lower portion (return run) 21, with the upper portion (conveying run) 20 supported by the conveyor bed 14. At least one longitudinal shield 22 (not shown in FIG. 8C) is movably attached to the frame 12 and is movable between at least opened and closed positions, the at least one longitudinal shield located laterally of at least the conveyor bed 14 when the shield is in the closed position.

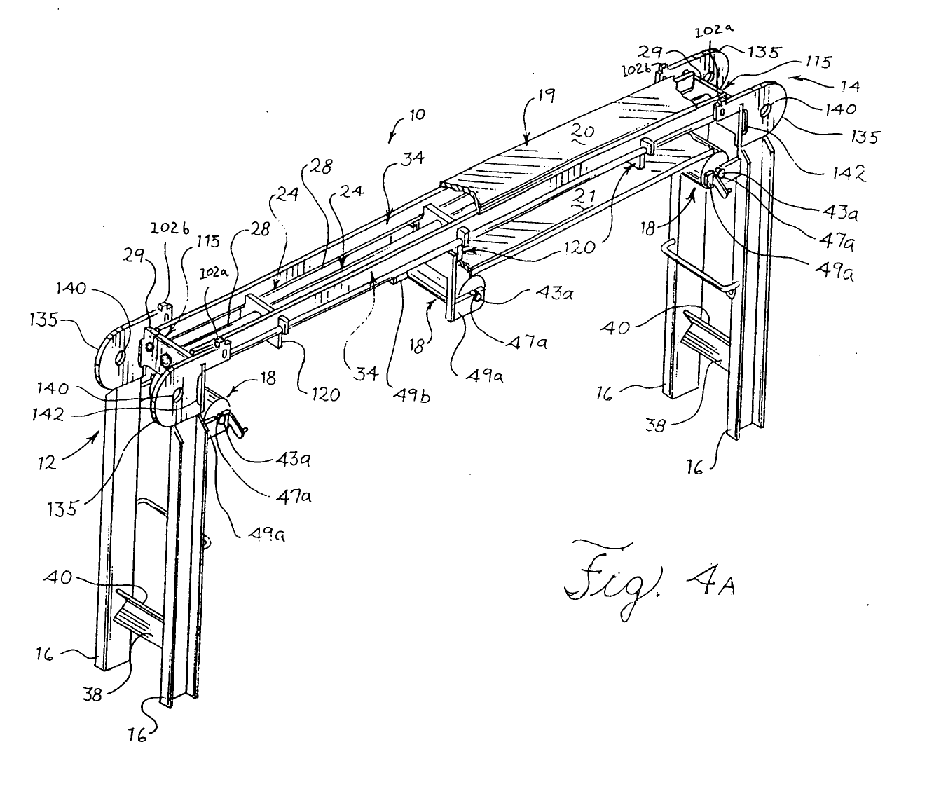

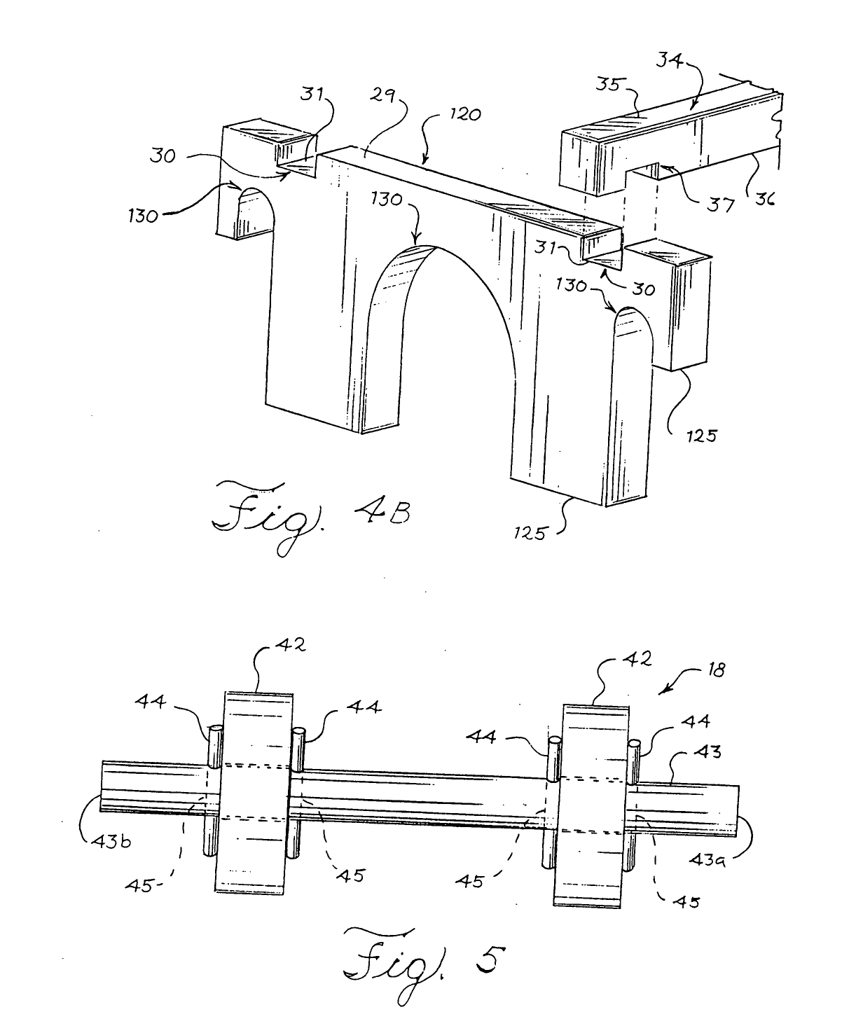

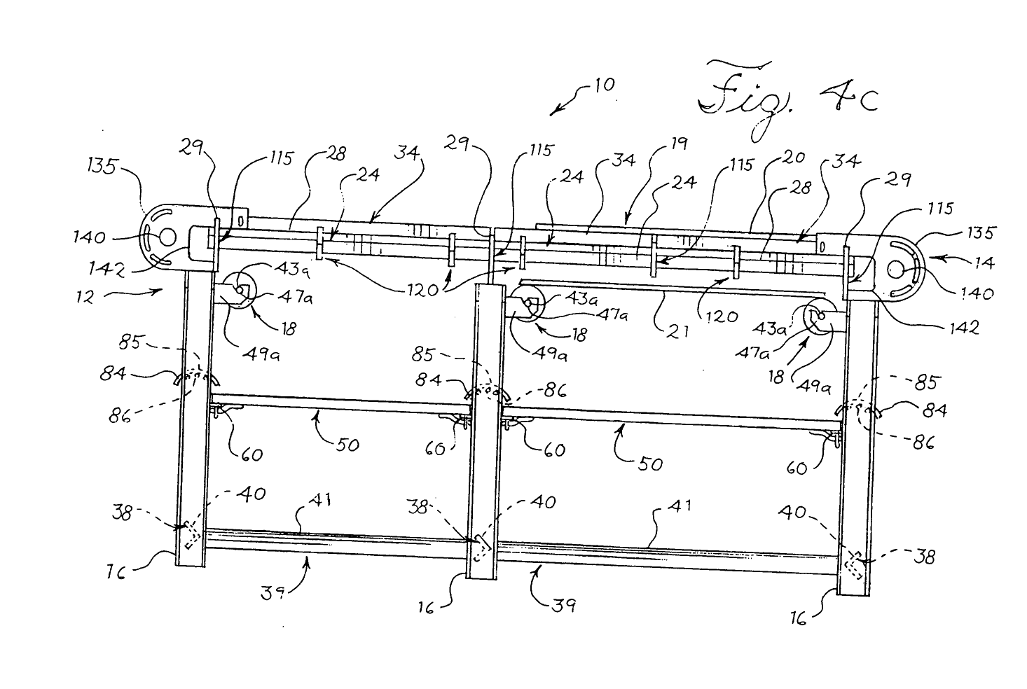

In one embodiment of the conveyor 10 illustrated in FIGS. 1, 2, 2B, 3 and 8C, the conveyor bed 14 of the frame 12, supported by the plurality of legs 16, comprises a plurality of longitudinal rails 24 having at least a sloped upper surface 28 and fixably connected to a plurality of cross members 26, with the cross members supporting a plurality of wear strips 34 (to be discussed further). In another embodiment of the conveyor 10 illustrated in FIGS. 4A, 4C, 8A and 8B, the conveyor bed 14 comprises a plurality of longitudinal rails 24 fixably connected to a plurality of end members 115. The bed further comprises a plurality of intermediate members 120 supporting a plurality of wear strips 34 located substantially between the end members 115, with the longitudinal rails 24 supporting the intermediate members 120 and having at least a sloped upper surface 28.

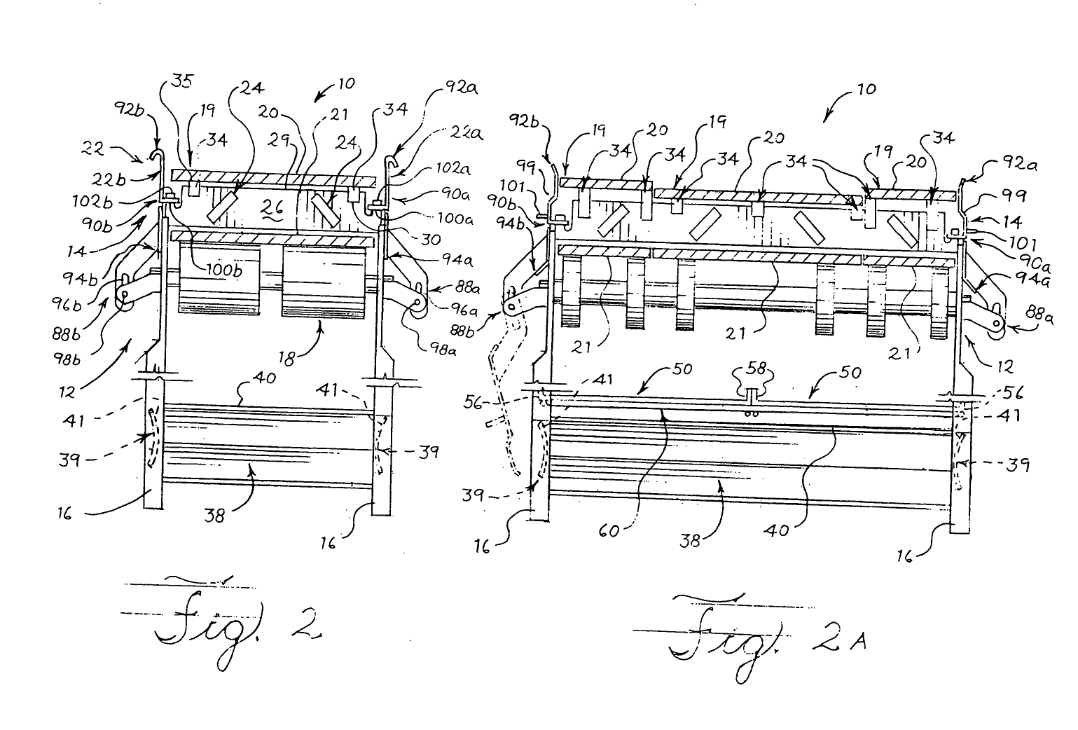

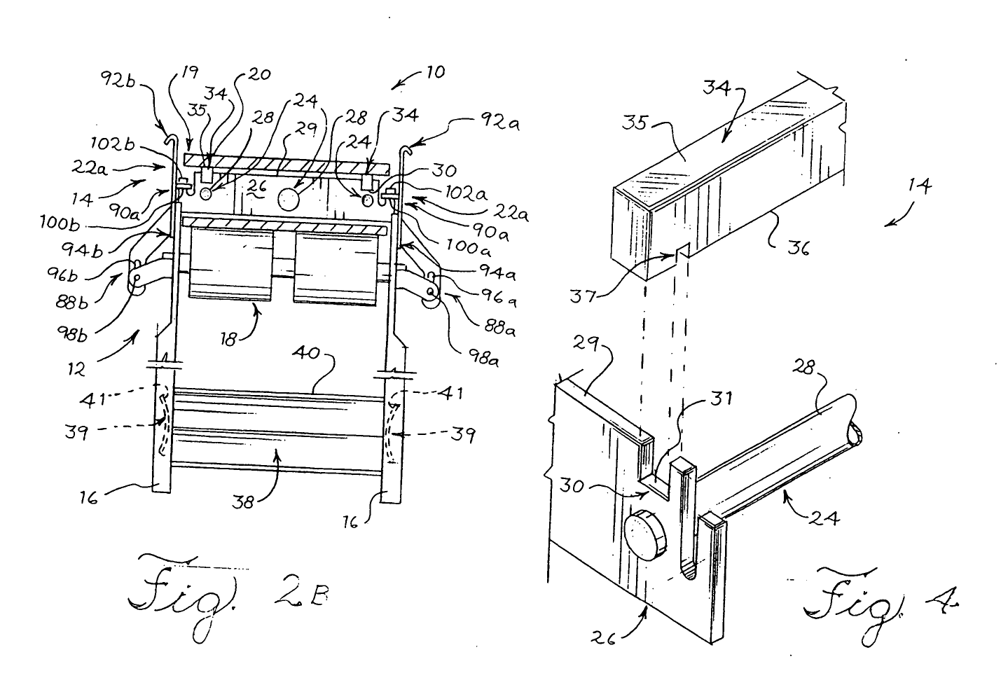

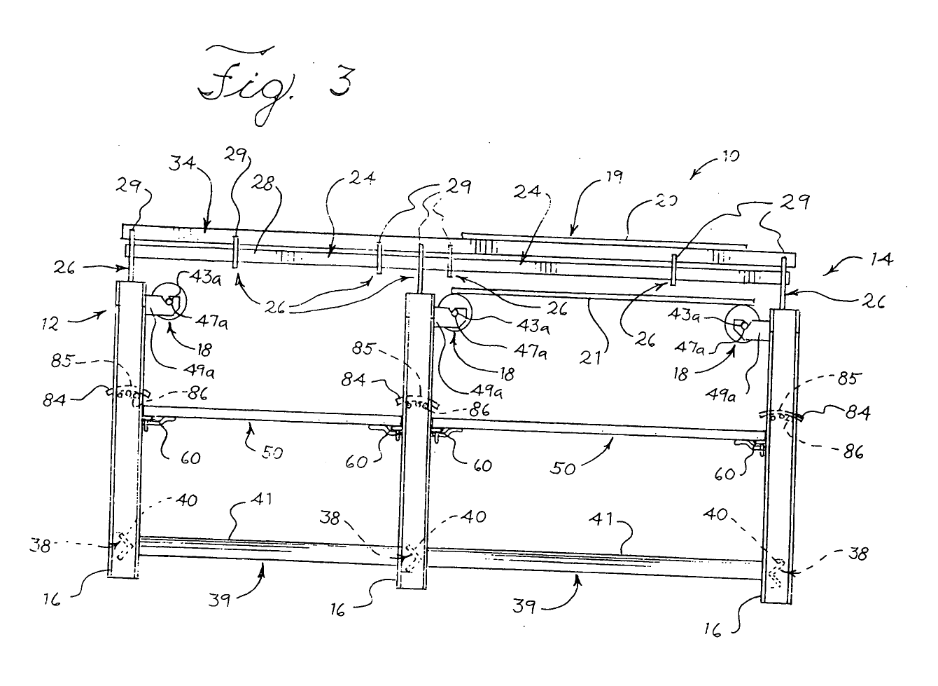

Regardless of embodiment, the longitudinal rails 24, running along the conveyor 10, are adapted to provide longitudinal support and rigidity to the conveyor's bed 14. The conveyor 10 may thus utilize any number of the plurality of longitudinal rails 24 adequate to provide such support and rigidity. For example, while FIGS. 1 and 2 illustrate a conveyor 10 having two longitudinal rails 24 of the plurality, it is understood, that additional longitudinal rails may be utilized in the conveyor as well if additional support and rigidity is desired. As illustrated in FIGS. 2A and 2B, such additional rails 24 may be arranged in parallel relation to one another, as may be required to support wider conveyors or conveyors utilizing more than one belt in parallel relation to one another. The additional rails 24 may also be arranged in series relation to one another, illustrated in FIGS. 3 and 4C, as may be required to support conveyors of extended length.

Regardless of the quantity utilized, in the preferred embodiment of the invention, the longitudinal rails 24 of the conveyor bed 14 have at least a sloped upper surface 28 to minimize the presence of horizontal surfaces and the resultant collection of particulate matter, residues or fluids thereon. To enable a sloping of the upper surface 28, the longitudinal rails 24 in one embodiment have a rectangular cross section (i.e., FIG. 2) and are fixably connected to the cross members 26 on a predetermined angle such that all of the surfaces of the rectangle are sloped from the horizontal. In embodiments of the invention utilizing rails of rectangular cross section, the rectangular cross section is angled from the horizontal by any degree that promotes drainage, preferably between about 5 and about 85 degrees, and more preferably between about 15 and about 45 degrees.

Although longitudinal rails 24 having a rectangular cross section are utilized in embodiments of the invention illustrated in FIGS. 1, 2, 2A, 3 and 8C, it is understood that rails having other cross sectional shapes may be utilized as well that minimize the presence of horizontal surfaces. The longitudinal rails 24 may thus have a circular (i.e., FIG. 2B), triangular, square or other cross section, assuming the rails having the square cross section are connected to the cross members 26 on an appropriate angle. FIGS. 2B, 4A, 4C, 8A and 8B thus illustrates an embodiment of the frame 12 comprising three longitudinal rails 24 having a sloped upper surface 28 enabled or defined by the round cross section of the rails. Although solid rails 24 are illustrated within the figures, it is understood that hollow rails may be utilized as well.

Referring again to FIGS. 1, 2, 2B, 3 and 8C illustrating embodiments of the conveyor bed 14 utilizing cross members 26, the plurality of the cross members of the conveyor bed, fixably connected to the longitudinal rails 24, are preferably disposed along and oriented transverse to the conveyor 10. In the preferred embodiment of the invention, each cross member 26 comprises a substantially upright bracket having an upper edge 29 and preferably having a predetermined maximum thickness sufficient to provide adequate structural rigidity to the conveyor 10. In having a predetermined maximum thickness, the upper edge 29 minimizes its associated horizontal surface area and the resultant undesirable collection of particulate matter, residues or cleaning fluids thereon.

As illustrated in FIGS. 1, 2, 2B, 8C and 4, each cross member 26 includes a plurality of indented seats 30 defined along its upper edge 29 for supporting a plurality of removable wear strips 34, the seats adapted to accept an insertion of the wear strips therein. Although removable wear strips 34 are preferred, it is understood that the wear strips may nonetheless be fixably secured to the cross members 26 as well. With the plurality of cross members 26 preferably removably supporting the plurality of wear strips 34, the plurality of wear strips of the conveyor bed 14 run along the conveyor 10, with each strip having an upper surface 35 that is in contact with the underside of an upper portion 20 of the at least one endless belt 19 and a lower surface 36 that is in contact with and supported by at least a lower surface 31 of the seat 30 (FIG. 4).

The plurality of wear strips 34 thus support the upper portion 20 of the at least one endless belt 19 and provide a low-friction contact surface for the belt's upper portion as it moves along the strips. In the preferred embodiment of the invention, the wear strips 34 are made of low-friction plastic approved by the USDA and FDA for food grade service. A preferred wear strip material may thus comprise ultra-high molecular weight (UHMW) polyethylene. While low-friction plastic is the preferred material of choice, it is understood that other low friction materials may be utilized as well, to include stainless steel, aluminum, various alloys, and/or composite materials.

As it is desirable that the upper portion 20 of the endless belt 19 contact the wear strips 34 and not the cross members 26 of the conveyor bed 14, the indentation of each seat 30 within a given cross member has a vertical depth that is less than the height or vertical depth (i.e. top-to-bottom thickness) of the associated wear strip, thus ensuring that the wear strip protrudes upwardly above the cross member. Because each wear strip 34 preferably has a square or rectangular cross section, the indentation of each seat 30 has square lower corners and a width to accept an insertion of the wear strip therein. When inserted into a given seat 30, a given wear strip 34 preferably is removably secured within the seat via a resistance fit between the seat and wear strip. Utilization of a resistance fit between the seat 30 and wear strip 34 thus allows for the simple installation and removal of the wear strips without the use of tools or fasteners.

A wear strip 34 can have any vertical depth or top-to-bottom thickness sufficient to elevate the upper portion 20 of the at least one endless belt 19 upwardly above the plurality of cross members 26. The vertical depth or top-to-bottom thickness of given wear strips thus establishes the elevation or height of the upper portion 20 of the at least one belt 19 supported thereon. As illustrated in FIG. 2A, the conveyor 10 may thus utilize sets of wear strips 34 having a common top-to-bottom thickness, different from the common thickness of other wear strip sets on the conveyor, to establish different relative elevations of the respective upper portions 20 of multiple belts 19.

Referring to FIG. 4, to further secure a given wear strip 34 within a given seat 30, the strip's lower surface 36 may optionally define a plurality of slots 37, with each slot adapted to accept an insertion of the lower surface 31 of the seat 30 of the cross member 26 therein. When inserted into a given slot 37, a given seat's lower surface 31 is preferably removably secured within the slot via a resistance fit between the slot and cross member 26 defining the seat 30. Utilization of a resistance fit between the slot 37 of the wear strip 34 and the cross member 26 defining the seat 30 thus allows for the simple installation and removal of the wear strips without the use of tools or fasteners. Again, it is desirable that the upper portion 20 of the at least one endless belt 19 contact the wear strips 34 and not the cross members 26. Thus, if utilizing slots 37 within a given wear strip 34, the indentation of each seat 30 within a cross member has a vertical depth that is less than the height or vertical depth (i.e. top-to-bottom thickness) of the associated wear strip above the slot, thus ensuring that the wear strip protrudes upwardly above the cross members.

Although wear strips 34 having a square or rectangular cross section are utilized in the preferred embodiment of the invention, it is understood that wear strips having any cross sectional shape may be utilized as well. Depending upon the cross sectional shape of the wear strips 34 utilized on the conveyor 10, the indentations of the seats 30 of the cross members 26 have a shape adapted to accept an insertion of the wear strips therein, with such indentations having a depth to ensure an upwardly protrusion of the wears strips above the cross members.

Referring again to FIGS. 4A, 4C, 8A and 8B illustrating embodiments of the conveyor bed 14 utilizing end members 115 and intermediate members 120, the longitudinal rails 24 of the plurality are fixably connected to a plurality of end members 115, with the longitudinal rails 24 supporting the plurality of intermediate members 120 and again having at least a sloped upper surface 28. The intermediate members 120, in turn, support the plurality of wear strips 34, with the wear strips preferably being located substantially between the end members 115. Again, the conveyor 10 may utilize any number of the plurality of longitudinal rails 24 adequate to provide support and rigidity to the bed 14. With regard to the sloped upper surface 28, FIGS. 4A, 8A and 8B illustrate embodiments of the bed having the three longitudinal rails 24 of round cross section. Again, however, longitudinal 24 rails having any cross-sectional shape may be utilized as well, with such rails defining at least a sloped upper surface 28.

The end members 115 of conveyor bed 14, fixably connected to the longitudinal rails 24, are preferably oriented transverse to the conveyor 10 and optionally disposed there-along, depending upon the conveyor's length. Each end member 115 comprises a substantially upright bracket having an upper edge 29 and preferably having a predetermined maximum thickness sufficient to provide adequate structural rigidity to the conveyor 10.

The intermediate members 120, preferably removably supported by the longitudinal rails 24, are disposed along and also oriented transverse to the conveyor, between the end members 115. In the preferred embodiment of the invention, the intermediate members 120 are made of plastic approved by the USDA and FDA for food grade service. A preferred material may thus comprise ultra-high molecular weight (UHMW) polyethylene. While food grade plastic is the preferred material of choice, it is understood that other materials may be utilized as well, to include stainless steel, aluminum, various alloys, and/or composite materials.

Referring to FIG. 4B, the intermediate members 120 comprise substantially upright brackets having an upper edge 29 and a lower edge 125. Each intermediate member 120 has a predetermined maximum thickness to minimize the collection of particulate matter and residues thereon. Each intermediate member 120 also includes a plurality of indented seats 30 defined along its upper edge 29 for supporting the plurality of removable wear strips 34, with the seats adapted to accept an insertion of the wear strips therein. Although removable wear strips 34 are preferred, it is understood that the wear strips may nonetheless be fixably secured to the intermediate members 120 as well. Again, with the plurality of intermediate members 120 preferably removably supporting the plurality of wear strips 34, the plurality of wear strips of the conveyor bed 14 run along the conveyor 10, with each strip having an upper surface 35 that is in contact with the underside of an upper portion 20 of the at least one endless belt 19 and a lower surface 36 that is in contact with and supported by at least a lower surface 31 of the seat 30. Each intermediate member 120 also defines a plurality of recesses 130 along its lower edge 125 adapted for removable engagement with the longitudinal rails 24.

As it is desirable that the upper portion 20 of the endless belt 19 contact the wear strips 34 and not the intermediate members 120, the indentation of each seat 30 within a given intermediate member has a vertical depth that is less than the height or vertical depth (i.e. top-to-bottom thickness) of the associated wear strip, thus ensuring that the wear strip protrudes upwardly above the intermediate member. Because each wear strip 34 preferably has a square or rectangular cross section, the indentation of each seat 30 has square lower corners and a width to accept an insertion of the wear strip therein. However, depending upon the cross sectional shape of the wear strips 34 utilized on the conveyor 10, the indentations of the seats 30 of the intermediate members 120 may have any shape adapted to accept an insertion of wear strips of any cross sectional shape therein, with such indentations having a depth to ensure an upwardly protrusion of the wear strips above the intermediate members. When inserted into a given seat 30, a given wear strip 34 preferably is removably secured within the seat via a resistance fit between the seat and wear strip.

With regard to the longitudinal rails 24 preferably removably supporting the intermediate members 120, depending upon the cross sectional shape of the longitudinal rails 24 supporting the intermediate members 120, the recesses 130 have a shape adapted to accept an insertion of the rails therein. FIG. 4B thus illustrates an intermediate member 120 having circular-shaped recesses for removable engagement with the circular rails of FIGS. 4A, 4C, 8A and 8B. However, it is understood that the recesses may be angular or trapezoidal in shape to accept an insertion of the rectangular-shaped rails therein, or of any shape to accept rails of any cross sectional shape therein as well. To ensure that the endless belt 19, supported by the wear strips 34, does not contact the end members 115 of the conveyor bed 14, the recesses 130 defined in the lower edge 125 of each intermediate member 120 have a vertical depth to ensure that the wear strips protrude upwardly above each end member such that each wear strip's upper surface 35 is located upwardly of each end member's upper edge 29.

With the intermediate members 120 supporting the wear strips 34 substantially between the end members 115 as illustrated in FIGS. 4A, 8A and 8B, it is thus desirable that the endless belt 19 supported by the wear strips contact the wear strips and not the end members. To ensure that no such contact occurs between the endless belt 19 and the end members 115, the upper edge 29 of each end member is disposed below the upper surface 35 of each wear strip. However, it is desirable that the upper edge 29 of each end member 115 be nonetheless located above the lower surface 36 of each wear strip 34 to ensure that the wear strips are longitudinally secured between the end members. Because a conveyance of the endless belt 19 across the upper surfaces 35 of the wear strips 34 exerts lateral frictional forces against the strips themselves, the end members 115 located at each end of the strips prevent a lateral movement of the strips resulting from such frictional forces.

Referring again to FIG. 4B, to further prevent a lateral movement of the wears strips and to secure a given wear strip 34 within a given seat 30 of an intermediate member 120, the strip's lower surface 36 may again optionally define a plurality of slots 37, with each adapted to accept an insertion of the lower surface 31 of the seat 30 of the intermediate member therein. When inserted into a given slot 37, a given seat's lower surface 31 is again preferably removably secured within the slot via a resistance fit between the slot and intermediate member 120 defining the seat 30, again allowing for the simple installation and removal of the wear strips without the use of tools or fasteners.

Again, it is desirable that the upper portion 20 of the at least one endless belt 19 contact the wear strips 34 and not the intermediate members 120 of the conveyor bed 14. Thus, if utilizing slots 37 within a given wear strip 34 as illustrated in FIG. 4B, the indentation of each seat 30 within an intermediate member has a vertical depth that is less than the height or vertical depth (i.e. top-to-bottom thickness) of the associated wear strip above the slot, thus ensuring that the wear strip protrudes upwardly above the intermediate members. Furthermore, to ensure that the endless belt 19, supported by the wear strips 34, does not contact the end members 115 of the conveyor bed 14 when utilizing such optional slots 37 in the wear strips, the height or vertical depth (i.e. top-to-bottom thickness) of the associated wear strip above the slot, when located within the seats 30 of the intermediate members 20, is sufficient to ensure that the wear strip protrudes upwardly above each end member such that each wear strip's upper surface 35 is located upwardly of each end member's upper edge 29.

Referring to FIGS. 1, 3, 4A, 4C, 8A, 8B and 8C, a plurality of legs 16 is disposed along the conveyor 10 to support the conveyor bed 14. In embodiments of the invention illustrated in FIGS. 1, 3 and 8A, the legs 16 are preferably disposed in paired relationship about at least two of the cross members 26 or end members 115 such that a given cross or end member is located between and fixably connected to a pair of the plurality of legs 16. In other embodiments of the invention, as illustrated in FIG. 4A, 4C, 8B and 8C, at least two of the cross members 26 or end members 115 of the conveyor bed 14 are each located substantially between a pair of connectors 135 of the frame 12 disposed proximal to the upper ends of the legs 16. Each connector 135 may be fixably connected to the upper end of each leg 16 via welded joint, or may be integral with the leg and defined as part of the leg's upper end. A through bore 140 is defined in each connector 135 such that the pair of connectors can operably engage the opposing axle ends of the at least one roller 18 of the conveyor 10. An access opening 142 is preferably also defined in each connector 135 to allow cleaning access to the exposed cylindrical body (to be discussed further) of the roller 18 having ends engaged with the bore 140 of each connector.

While it is understood that the legs 16 or connectors 135 may be disposed about only those cross members 26 or end members 115 located at respective ends of the conveyor 10, the legs may also be disposed about one or more additional cross members or end members located along the conveyor as well (i.e. FIGS. 3 and 4C). The determination of the quantity and placement of the leg pairs of the plurality of legs 16 utilized to support a given conveyor bed 14 depends on the desired span of the conveyor between leg pairs, with the determination of desired span depending on the conveyor and product weight, conveyor length, and other relevant factors. Thus, depending on the desired span utilized for a given conveyor 10, a pair of legs 16 may be disposed about and affixed to each of the cross members 26 or end members 115 located along the conveyor, as illustrated in FIGS. 1 and 8A. A pair of legs 16 may also be disposed about and affixed to only selected cross members 26 or end members 115 located along the conveyor 10, as illustrated in FIGS. 3, 4C and 8C, thus resulting in some cross members or end members of the conveyor not having legs attached thereto.

As illustrated on FIGS. 1, 2, 2A, 2B, 3, 4A, 4C and 8C, at least one leg brace 38 may be fixably connected between paired legs 16 and below a given cross member 26 or end member 115 to secure the legs 16 of a given pair together for added lateral support. Optionally, at least one strut 39 may be fixably connected between legs 16 located on a common side of the conveyor 10 for added longitudinal support (FIGS. 2, 2A, 2B, 3 and 4C). Similar to the longitudinal rails 24, both the leg braces 38 and the optional struts 39 have at least a sloped upper surface, respective surfaces 40 and 41, to minimize the presence of horizontal surfaces and the resultant collection of particulate matter, residues or fluids thereon.

To enable a sloping of the respective upper surfaces 40 and 41, both the leg braces 38 and optional struts 39 preferably have a “V-shaped” or “crescent-shaped” cross section and are mounted on a predetermined angle to the legs 16 such that all of the surfaces of the “V” or “crescent” are self draining and not hidden from view. In the preferred embodiment of the invention, the “V-shaped” or “crescent-shaped” cross section is oriented in relation to the legs such that the open void or cavity defined by the “V” or “crescent” is oriented at least laterally. The “V” or “crescent” is thus angled from the vertical (i.e. from the position where the void or cavity is directed upwardly) by any degree that promotes drainage, preferably by at least about 45 degrees.

Although leg braces 38 and optional struts 39 having a “V-shaped” or “crescent-shaped” cross section are utilized in the preferred embodiment of the invention, it is understood that the braces and optional struts may have additional cross sectional shapes as well that minimize the presence of horizontal surfaces. The leg braces 38 and optional struts 39 may thus have a circular, triangular, square, rectangular or other cross section, assuming the braces and struts having the square or rectangular cross sections are connected to the associated legs 16 on an appropriate angle.

Referring to FIGS. 1, 2, 2B, 3, 4A, 4C, 8A, 8B and 8C, the at least one rotatable roller 18 is preferably removably supported by the frame 12 and in contact with the at least one endless belt 19. One or more rollers of the at least one roller 18 may be rotatably driven by a motor (not shown) or may be non-driven (i.e. idler roller(s)). Such rollers of the at least one rotatable roller 18, although preferably removably supported by the frame 12, may be fixably supported by the frame as well. Also, any quantity of the at least one roller 18 may be located on the conveyor 10 as well, with such quantity comprising only one roller (typically used with a “bull-nosed” conveyor, not shown), two rollers, or any quantity of driven and/or non-driven rollers.

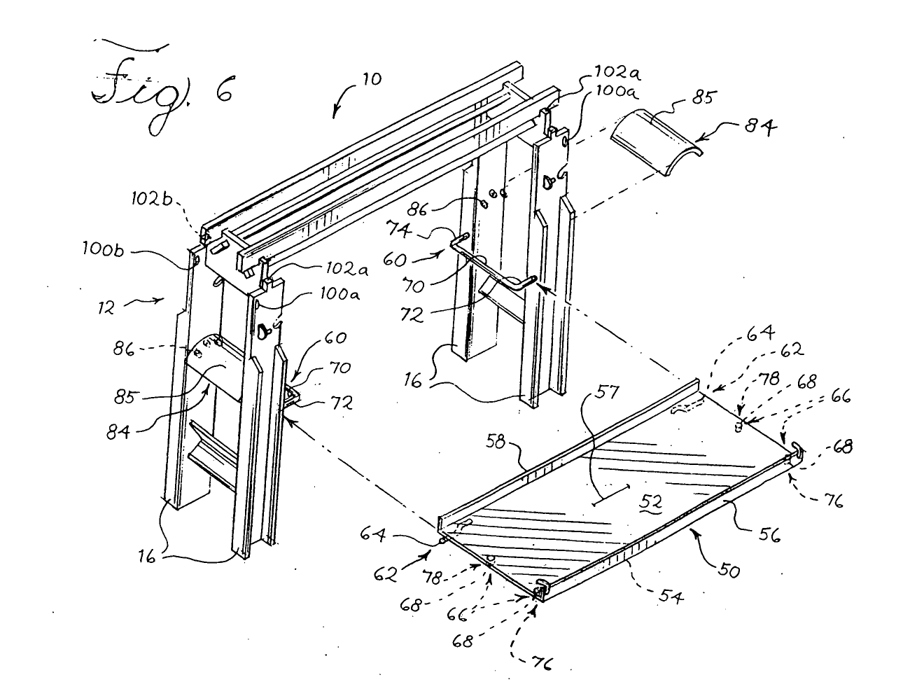

As shown in FIG. 5, the at least one roller 18 in one embodiment is comprised of at least one substantially cylindrical body 42 of solid material rotatably mounted in concentric relation to an axle 43. The at least one cylindrical body 42 is preferably comprised of stainless steel, plastic or composite material approved by the USDA or FDA for food grade service. Collars may be secured to the axle 43 on both sides of a given cylindrical body 42 to prevent the body from translating along the axle. Also, one or more bearing assemblies may be located between a given cylindrical body 42 and axle 43 to allow the body to rotate in relation to the axle with minimal frictional resistance.

In the embodiment of the invention shown in FIG. 5, the at least one roller 18 utilizes a pin 44 in place of a collar on each side of a given cylindrical body 42 to prevent the body from translating along the axle 43. Each pin 44 is preferably inserted through a respective opening 45 defined in the axle and then secured in place with a weld. Because the cylindrical bodies 42 will be rotating slowly around axle 43, no bearings are required between the respective mating surfaces 46 of the body and axle. In using pins in place of collars to secure the respective bodies 42 in place on the axles 43, and in not using bearings between the mating surfaces 46 of the bodies and axles, cleaning personnel can readily direct a stream of cleaning fluid into such mating surfaces during cleaning operations. The axle is preferably comprised of stainless steel or some other corrosion resistant material and has opposing ends 43a and 43b that protrude outwardly of the at least one cylindrical body 42.

At least one pair of receivers 47a and 47b is thus defined within the frame 12 for the at least one roller 18 and is adapted for operable engagement with the opposing ends 43a and 43b of the axle 43. In the embodiment of the conveyor 10 illustrated in FIG. 1, each receiver 47a and 47b of the at least one pair comprises a downwardly-directed, elongated recess defined in each leg 16 of a corresponding leg pair on the frame 12 and adapted for removable, sliding engagement with an axle end. In other embodiments of the invention illustrated in FIGS. 3, 4A, 4C, 8A, 8B and 8C, each receiver 47a and 47b is defined in a respective receiver flange 49a and 49b of the frame 12, connected to the frame via either the legs 16 or longitudinal rails 24 of the conveyor. The axle ends 43a and 43b of the at least one roller 19 may also operably engage the bore 140 defined in each connector 135 of the frame. Although the at least one roller 18 in one embodiment comprises at least one cylindrical body 42 mounted in concentric relation to an axle 43 defining ends 43a and 43b, it is understood that the at least one roller may be unitary as well wherein the at least one cylindrical body and the axle defining the two ends are comprised of a single, solid material (i.e. food-grade plastic, aluminum, stainless steel, etc.), with such axle ends rotating within the respective receivers 47a and 47b or bores 140.

The downwardly direction of the recesses enables the at least one roller 18 to remain removably supported by the frame 12 via the weight of the roller and/or the belt tension pushing against the roller. Utilization of downwardly directed recesses allows for the simple installation and removal of the at least one roller 18 within the receivers of the frame 12 without the use of tools or fasteners. The use of fasteners such as bolts, nuts and washers to removably attach the at least one roller 18 to the frame is undesirable because such fasters require the use of tools to add or remove them and also establish areas where particulate matter and/or residues from conveyed food products may collect, thus making the areas prone to contamination.

Referring now to FIGS. 1, 2, 2A, 2B, 3, 4A, 4C, 8A, 8B and 8C, at least one endless belt 19 is in contact with the at least one roller 18. The at least one endless belt 19 defines an upper portion or conveying run 20 and a lower portion or return run 21, with the upper portion or conveying run supported by the conveyor bed 14. The at least one endless belt 19 may be a conventional, commercially available plastic link belt hinged by a plurality of transverse rods or any composite closed cell belt, including seamless rubber rubber/composite or urethane, that neither sheds nor wicks solutions or contaminants. The upper portion or conveying run 20 of the at least one endless belt 19 passes over and is supported by the wear strips 34 of the conveyor bed 14 while the lower portion or return run 21 is disposed below the wear strips, cross members 26 or end and intermediate members 115 and 120, and longitudinal rails 24 of the bed 14.

As illustrated in FIG. 2A, more than one belt of the at least one belt 19 may be utilized on the conveyor 10. FIG. 2A thus illustrates three belts 19 located in parallel relation to one another. As illustrated therein, each belt 19 has respective upper and lower portions (conveying and return runs) 20 and 21, with the upper portions of the respective belts supported by respective wear strips 34 of the conveyor bed 14.

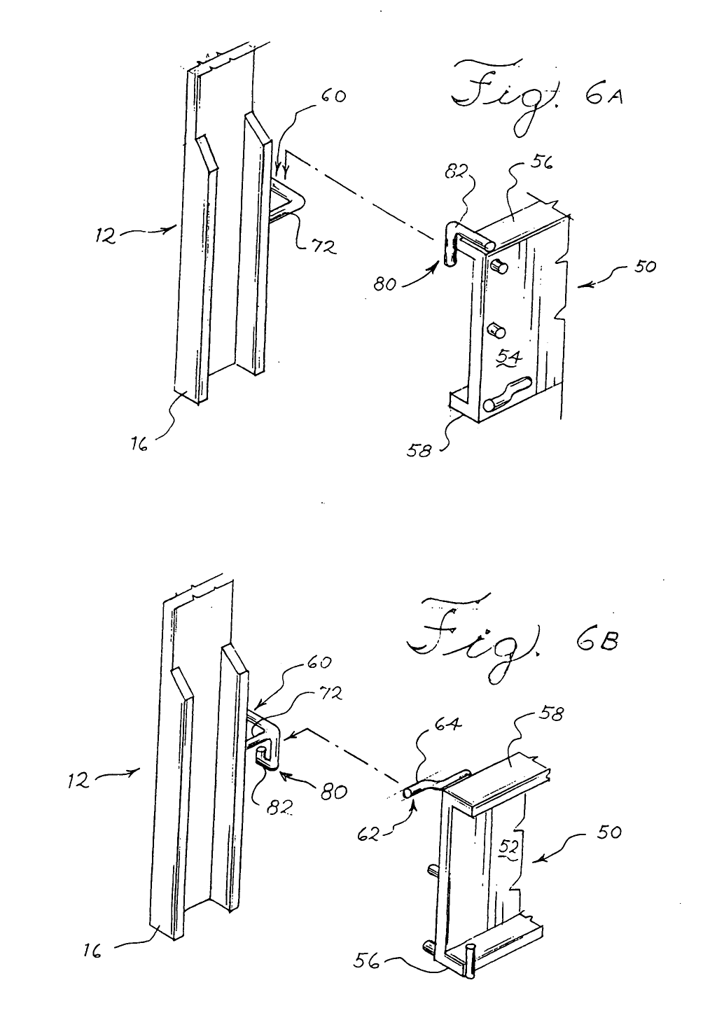

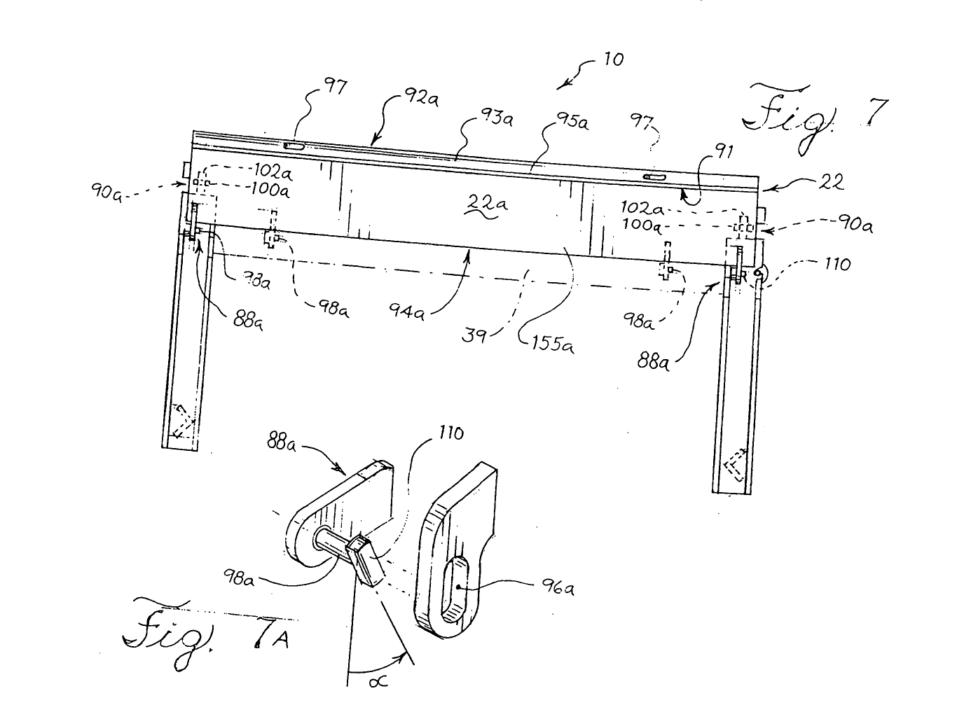

Referring to FIG. 6 (showing frame 12 of the conveyor 10 with the at least one belt 19 and shield 22 omitted for clarity), at least one catch pan 50, having upper and lower surfaces 52 and 54 and leading and trailing edges 56 and 58, may be removably supported by the frame 12 of the conveyor 10 below the lower portion or return run 21 of the at least one endless belt 19. The upper surface 52 of the at least one pan 50 catches any wayward particulate matter and/or residual drips that may fall from the lower portion or return run 21 of the belt 19. Of course, such particulate matter and/or residues may collect on the upper portion or conveying run 20 of the at least one belt 19 during food processing operations. The at least one catch pan 50 is thus removable from the frame 12 of the conveyor 10 during cleaning operations so that cleaning personnel can remove the particulate matter and/or drips deposited thereon by the at least one belt 19 and thereafter clean and sanitize the pan.

In the preferred embodiment of the invention, the at least one catch pan 50 is removably supported by at least two supports 60 fixably attached to the frame 12, with the at least two supports preferably engaging the lower surface 54 of the pan to allow a sliding movement of the pan in relation to the frame 12. As illustrated in FIG. 6, the at least two supports 60 each preferably comprise a substantially horizontal rod extending from respective pairs of legs of the plurality of legs 16.

A retaining means 62 operably engages the supports 60 to removably retain the at least one catch pan 50 in a substantially horizontal orientation in relation to the frame 12 while located in a plurality of positions on the frame. In the preferred embodiment of the invention, the retaining means 62 comprises at least two fingers 64 extending laterally from the lower surface 54 of the pan 50, proximal to the pan's trailing edge 58, for operable engagement with the at least two supports 60 of the frame 12. Each support 60 is located between each respective finger 64 and the lower surface 54 of the at least one pan 50 when operably engaged. Thus, when a leading edge 56 of the pan is pulled outwardly away from the conveyor 10, the fingers 64 upwardly abut the respective supports 60 to prevent the leading edge of the pan from tipping or moving downwardly in relation to the frame 12 (i.e. due to gravity or other forces).

Referring again to FIG. 6, an adjustment means 66 also operably engages the supports 60 to define a plurality of positional relationships between the at least one catch pan 50 and the frame 12. In the preferred embodiment of the invention, the adjustment means 66 comprises a plurality of stops 68 located on the lower surface 54 of the at least one pan 50 for operable engagement with the at least two supports 60 of the frame 12. The stops preferably protrude downwardly from the pan's lower surface 54 for operable engagement with at least two closed pathways 70 defined by the respective supports 60, with each closed pathway defining leading and trailing ends 72 and 74.

The stops 68 engage the leading and trailing ends 72 and 74 of the respective pathways to selectively restrict the sliding movement of the at least one catch pan 50 in relation to the frame 12. In the preferred embodiment of the invention, the plurality of stops 68 comprises at least two pairs, namely a leading pair 76 and a trailing pair 78, with the stops of a given pair preferably located in opposite relation to one another along respective sides of the at least one pan 50.

The leading pair 76 of stops 68 is preferably located proximal to the leading edge 56 of the at least one pan 50. The leading pair 76 protrudes downwardly into the respective pathways 70 of the supports 60 and abuts the leading ends 72 of the pathway to prevent any outward sliding movement of at least the leading edge 56 of the at least one pan 50 from the frame 12. A lifting of the leading edge 56 of the pan 50 in an upwardly direction to lift the leading pair 76 of stops above the respective leading ends 72 of the pathways 70 will permit a subsequent outward sliding movement of at least the leading edge of the pan in relation to the frame 12.

The trailing pair 78 of stops 68 is preferably located proximal to an approximate midpoint 57 defined between the leading and trailing edges 56 and 58 of the at least one pan 50. The trailing pair 78 protrudes downwardly into the respective pathways 70 of the supports 60 and abuts the leading ends 72 of the pathways to prevent a further outward sliding movement of the pan from the frame 12 after the leading pair 76 of the stops has been removed from within the respective pathways.

Thus, when located within the respective pathways 70, the trailing pair 78 of stops allows the at least one pan 50 to be pulled outwardly from the frame to the point they abut the respective leading ends 72 of the pathways, namely to about the approximate midpoint 57 of the pan. A lifting of the leading edge 56 of the at least one pan 50 in an upwardly direction to lift the trailing pair 78 of stops above the leading ends of the respective pathways 70 of the supports 60 will permit a subsequent further outward sliding movement of the pan in relation to the frame 12, thus facilitating a removal of the pan from the frame of the conveyor 10, if desired.

Although the at least one pan 50 may include the retaining means 62 or the adjustment means 66 exclusive of one another, in the preferred embodiment of the invention, the pan includes both means in combination with one another. When included in combination, the retaining means 62 prevents the leading edge 56 of the at least one pan 50 from tipping or moving downwardly throughout the various positional relationships defined between the pan and the frame 12 by the adjustment means 66. For example, the retaining means 62 will prevent the leading edge 56 of the at least one pan 50 from tipping or moving downwardly (i.e. due to gravity or other forces) when the trailing pair 78 of stops 68 abut the leading ends 72 of the respective pathways 70, and also during any subsequent further outward sliding movement of the pan in relation to the frame 12.

It is noted from the foregoing description that the location of the at least two pairs of stops on the at least one pan 50 defines at least two positional relationships between the pan and frame 12. With the leading pair 76 of stops abutting the leading ends 72 of the respective pathways, a first positional relationship is defined wherein the pan is in a “catch position.” When in the “catch position,” the leading edge 56 of the at least one pan 50 is located proximal to the leading ends 72 of the respective pathways 70 such that the pan is under the lower portion 21 of the at least one belt 19 to catch any wayward particulate matter and/or residual drips that may fall from the belt during food processing operations.

With the trailing pair 78 of the stops abutting the leading ends 72 of the respective pathways 70, a second positional relationship is defined wherein the pan is in a “pre-cleaning position.” When in the “pre-cleaning position,” the leading edge 56 of the at least one pan 50 is located outwardly of the frame 12, with the pan's approximate midpoint 57 located proximal to the leading ends 72 of the respective pathways 70. The retaining means 62 prevents the leading edge 56 of the at least one pan 50, located outwardly of the frame 12, from tipping or moving downwardly (i.e. due to gravity or other forces). The “pre-cleaning position” enables the pan to be located in a position where cleaning personnel can readily wipe or sweep particulate matter there-from and into a receptacle without having to completely remove the pan from the frame of the conveyor.

Although at least two positional relationships are defined in the preferred embodiment of the invention, it is understood that additional pairs of stops 68 may be located on the at least one pan 50 to define other positional relationships between the pan and frame 12 in addition to the “catch” and “pre-cleaning” positions described above.

Referring to FIGS. 6A and 6B, an engagement means 80 removably engages the at least one catch pan 50 to the frame in a non-horizontal position after the pan has been removed from its location on the frame 12 below the lower portion 21 of the at least one endless belt 21. Maintaining the at least one pan 50 in a non-horizontal position promotes the draining of cleaning fluids there-from during cleaning or sanitization operations. In one embodiment of the invention illustrated in FIG. 6A, the engagement means 80 operably engages the supports 60 to removably engage the at least one pan 50 to the frame 12 in a non-horizontal position. As illustrated therein, the engagement means 80 comprises at least two hooks 82 fixably attached to either the leading or trailing edges 56 or 58, or to both edges of the at least one pan 50, and adapted for engagement with the respective supports 60 of the frame. Although FIG. 6A illustrates hooks 82 attached to the leading edge 54 of the catch pan 50, it is understood that the hooks can be attached to the trailing edge 58 as well. In another embodiment illustrated in FIG. 6B, the engagement means 80 is attached to the supports 60 of the frame 12 for engagement with the retaining means 62 to removably engage the at least one pan 50 to the frame in the non-horizontal position. Thus, the at least two hooks 82 of the engagement means 80 are fixably attached to the at least two supports 60 of the frame 12, proximal to the respective leading ends 72 of the pathways 70, and adapted for engagement with the at least two fingers 64 of the retaining means 62.

Thus, in the embodiment illustrated in FIGS. 6A and 8A, after the at least one pan 50 has been removed from its location on the frame 12 below the lower portion 21 of the at least one belt 19, personnel relocate the pan on the frame such that the at least two hooks 82 removably engage the at least two supports 60 of the frame, proximal to the respective leading ends 72 of pathways 70, to maintain the pan in a non-horizontal “sanitize position” during cleaning operations. In the embodiment illustrated in FIGS. 6B and 8B, after the pan 50 has been removed from its location on the frame 12, personnel relocate that pan on the frame such that the at least two fingers 64 of the retaining means 62, extending laterally from the lower surface 54 of the pan 50 proximal to the pan's trailing edge 58, removably engage the at least two hooks 82 respectively located on the at least two supports 60 of the frame, to maintain the pan in a similar non-horizontal “sanitize position” during cleaning operations.

In view of the foregoing, the at least one catch pan 50 is thus movable between at least “catch,” “pre-cleaning” and “sanitize” positions. In operation, the at least one pan 50 is initially located on the frame 12 in a “catch position,” below the lower portion 21 of the at least one belt 19, to catch wayward particulate matter and/or drips falling from the belt during food processing operations. During cleaning procedures, cleaning personnel slide the at least one pan 50 outwardly from the frame 12 to the “pre-cleaning position” via the adjustment means 66, thereafter wiping or sweeping any particulate matter or drips from the pan without having to remove the pan from the frame of the conveyor. The retaining means 62 prevents the leading edge of the pan 50 from tipping or falling to the floor at any time during the cleaning procedure, thus avoiding contamination from the floor.

After personnel have wiped or swept the at least one pan 50 free of particulate matter and/or drips, the pan is relocated to the “sanitize position” via the engagement means 80. While in the sanitize position, (i.e. hanging preferably substantially vertically from the frame of the conveyor as illustrated in FIGS. 6A, 6B, 8A and 8B), the pan is cleaned and sanitized by personnel using steam, hot water and/or chemicals. The engagement means 80 allows any remaining cleaning fluids to readily drain from the surfaces of the at least one 50 pan, and further allows cleaning personnel to avoid placing the pan on the floor or other surfaces during cleaning procedures, thus avoiding contamination from the floor or such other surfaces.

Although FIG. 6 illustrates the conveyor 10 having only one pan of the at least one pan 50, it is understood that additional pans may be utilized in the conveyor as well. For example, as illustrated in FIGS. 3 and 4C, additional pans 50 may be located on the conveyor 10 in series relation to one another, as may be required for conveyors of extended length having multiple cross or end members and associated leg pairs located at multiple intervals. When in series arrangement, the pans rest on additional supports 60 provided on associated corresponding leg pairs of the plurality of legs 16.

The pans 50 may also be may be arranged in parallel relation to one another, as may be required with wider conveyors or conveyors utilizing more than one belt in parallel relation to one another. When in a parallel arrangement, as shown in FIG. 2A, the pans 50 rest on common supports 60 located between corresponding leg pairs of the plurality of legs 16. The respective trailing edges 58 of the pans 50 are preferably located proximal to one another, with each pan located below the lower portion 21 of the at least one belt 19. Their respective leading edges 56 are preferably located on opposite sides of the conveyor 10 and facing outwardly there-from such that each pan 50 could be pulled outwardly from their respective sides of the conveyor during cleaning procedures. Regardless of the quantity and placement of the pans 50 on the conveyor 10, each pan may include the retaining means 62, adjustment means 66 and/or engagement means 80 as discussed herein.

Referring again to FIGS. 3, 4C and 6, at least one hood 84 may be removably located between paired legs of the plurality of legs 16, below the associated cross member 26 or end member 115. In the preferred embodiment of the invention, each hood 84 is located upwardly of the support 60 of the frame 12 and has at least a sloped upper surface 85 that overlaps the at least one catch pan 50 to deflect any particulate matter or drips onto the pan that may fall between leg pairs from the endless belt 19.

To enable a sloping of the upper surface 85, each hood 84 preferably has a “V-shaped” or “crescent-shaped” cross section oriented in an inverted position (i.e. the void or cavity defined by the “V” or “crescent” directed downwardly) in relation to the legs 16 to deflect any falling particulate matter or drips to the at least one catch pan 50 located below. In the preferred embodiment of the invention, each hood 84 is removably located on at least a plurality of rests 86 that protrude inwardly from each leg 16 of the associated pair such that a given hood may be readily removed from the frame 12 during cleaning operations.

Referring to FIGS. 1, 2, 2B, 7, 8, 8A, 8B and 10, at least one longitudinal shield 22 is movably attached to the frame 12 of the conveyor 10. The at least one shield, illustrated by example as shields 22a and 22b, is movable between at least opened and closed positions and is located laterally of at least the conveyor bed 14 when the shield is in the closed position. Although, for the sake of example, FIGS. 1, 2, 2B, 7, 8, 8A and 8B illustrate conveyor 10 having two longitudinal shields 22a and 22b, it is understood that fewer or additional shields may be utilized in the conveyor as well (to be discussed further).

The movable attachment of the at least one longitudinal shield 22 to the frame 12, shields 22a and 22b, comprises respective pivot means 88a and 88b and respective securement means 90a and 90b. Each pivot means enables a pivoting and translating movement of a given shield between opened, closed and secured positions on the frame 12 while each securement means releasably retains the shield in the closed position to the frame.

Viewing the at least one shield 22 in a closed position in relation to the frame 12, each shield 22a and 22b comprises a substantially longitudinal panel having respective upper edges 92a and 92b and lower edges 94a and 94b, and defines respective inner surfaces 150a and 150b, and outer surfaces 155a and 155b. The vertical distance between the upper and lower edges of each shield is predetermined such that a given shield is located laterally of at least the conveyor bed 14 when in the closed position. Each shield may also have an increased vertical distance between its respective upper and lower edges such that a given shield, when in the closed position, is located laterally of both the upper and lower portions (conveying and return runs) 20 and 21 of the at least one endless belt 19 (omitted from FIGS. 7 and 8 for clarity), and optionally located laterally of the at least one roller 18 as well. For embodiments of the conveyor 10 utilizing connectors 135 as part of the frame 12 (FIGS. 4A, 4C, 8B and 8C), each shield preferably defines a longitudinal distance between its ends such that the shield, when in the closed position, is located laterally of the access opening 142 defined in each connector.

Thus, when in the closed position, each shield 22a and 22b of the at least one shield 22 is in a substantially vertical position and covers a side of at least the bed 14 and optionally the upper and lower portions 20 and 21 of the at least one endless belt 19 and/or the at least one roller 18 to prevent any interference with these components by personnel using the conveyor, thus preventing possible injury to these personnel. Also when in the closed position, the respective upper edges 92a and 92b of the shields 22a and 22b may be located upwardly of the upper portion 20 of the at least one belt 19 (supported by the wear strips 34) by a predetermined distance to function as guide-ways that prevent conveyed food products from falling from the outer edges of the belt's upper portion during production operations.

In one embodiment of the conveyor 10 illustrated in FIGS. 7, 8 and 9, the upper edges 92a and 92b of the respective shields 22a and 22b of the at least one shield 22 define at least one sloped upper surface, i.e. surfaces 93a and 93b, respectively, to minimize the presence of horizontal surfaces and the resultant collection of particulate matter, residues, or fluids thereon. Preferably, the at least one sloped surfaces 93a and 93b respectively slope downwardly and outwardly of the conveyor 10 by a predetermined angle to direct any particulate matter, residues or fluids away from the endless belt 19 and any food products being conveyed. In the preferred embodiment of the invention, the upper surfaces of the respective shields, when in the closed position, are angled from the horizontal by any degree that promotes drainage, preferably between about 5 and about 85 degrees, and more preferably between about 15 and about 45 degrees.

The upper edge of each shield may also define at least one secondary surface (respective secondary surfaces 95a and 95b) located adjacent to each upper surface (respective upper surfaces 93a and 93b). In the preferred embodiment, each respective secondary surface 95a and 95b preferably has a substantially vertical orientation and is located outwardly of each respective upper surface 93a and 93b in relation to the respective shields 22a and 22b when in the closed position. The at least one secondary surface of each shield both reinforces the upper edge of the shield and provides a contact surface against which personnel may lean during production operations.

As shown in FIGS. 7, 8 and 9, the at least one secondary surface of each shield, in combination with the sloped upper surface, also defines a handle 91 that may be grasped by personnel during at least opening and closing movements of the shield. Also, at least one through opening 97 may be defined within the respective sloped upper surfaces 93a and 93b of the shields 22a and 22b. In the preferred embodiment of the invention, the at least one through opening 97 comprises a longitudinal slot defined between the sloped upper surface and panel of each shield, as shown in FIGS. 7, 8 and 9. One or numerous such slots may thus be located in each shield. The at least one opening 97 in each shield functions as a drainage hole for cleaning fluids that may collect at the undersides of the sloped surfaces while cleaning the at least one shield 22 (i.e., shields 22a and 22b) in an opened position (to be discussed further).

While the upper edges 92a and 92b of respective shields 22a and 22b preferably define sloped upper surfaces 93a and 93b and secondary surfaces 95a and 95b respectively, it is understood that, as illustrated in FIGS. 2A, 8A and 8B, the sloped upper surfaces and the secondary surfaces may be omitted from the shields such that the respective upper edges 92a and 92b of the shields are defined simply by the upper edges of the panels themselves. A slight break 99 may be located proximal to each upper edge for added structural rigidity to the panel. In utilizing an embodiment of the panels shown in FIGS. 2A, 8A and 8B not having respective sloped and secondary surfaces, at least one wire-type or rod-type handle 101 (FIG. 2A) may be located on an outer surface of a given panel of the at least one shield 22 to facilitate a gripping of a given shield during at least opening and closing movements.

Referring to FIGS. 8A and 8B, at least one shelf 160 may be defined on the at least one movable shield 22 for removably supporting at least one of the removable wear strips 34, and optionally at least one of the intermediate members 120 (both illustrated in FIG. 8B only for clarity), during cleaning operations. It is understood that the at least one shelf 160 may be defined on only one shield of the at least one shield 22, or on any number of shields if more than one shield is present on the conveyor 10. As illustrated in FIGS. 8A and 8B, the at least one shelf 160 is preferably defined on the inner surface 150 of a given shield 22 (illustrated by example on inner surface 150a of the shield 22a), preferably proximal to the shield's lower edge 94b, such that the shelf is readily accessible when the shield is in the opened position, as shown. Although two shelves 160 are illustrated by way of example in FIGS. 8A and 8B, it is understood that fewer or additional shelves may be utilized as well, preferably in relation to the number of intermediate members utilized on the conveyor 10 (to be further discussed).

Each shelf 160 comprises a shoulder 162 oriented preferably perpendicular to the inside surface 150b of the at least one shield 22b and defining a resting surface 165 adapted to support one or more of the removable wear strips 34 of the conveyor bed 14. The resting surface 165 is of a length sufficient to support one, two or any number of wear strips resting thereon (only one wear strip 34 illustrated in FIG. 8B for clarity), with multiple wears strips arranged either laterally of one another or on top of one another. Each shelf 160 further comprises a stay 170 located at an end of the resting surface 165, outwardly of the shield's inner surface 94b. The stay 170 extends upwardly from the resting surface 165 to define an inner securing surface 175 adapted to secure the one or more wear strips 34 on the shelf 160 to prevent them from falling outwardly from the shoulder 162.

The upwardly extending stay 170 of the at least one shelf 160 terminates at a tip 180 adapted for insertion into a bore 185 optionally defined in each of the removable intermediate members 120 (FIG. 8B). Thus, for embodiments of the conveyor utilizing the removable intermediate members 120, the insertion of the tip 180 of the stay 170 into the bore 185 of a given intermediate member allows the shelf 160 to removably support the member during cleaning operations. To ensure that each intermediate member 120 of the conveyor's bed 14 is supported by a shelf 160 during such cleaning operations, the number of shelves located on a given conveyor is preferably at least equal to the number of intermediate members utilized.

Thus, during cleaning operations in one embodiment of the conveyor 10, the at least one longitudinal shield 22 is moved to an opened position to make the at least one shelf 160, located on a given shield's inner surface, accessible. The endless belt 19 is thereafter removed from the conveyor bed 14 and the wear strips 34 are removed from the seats of 30 of the cross members 26, or from the removable intermediate members 120 if utilized on the conveyor. The wear strips 34 are thereafter placed on the shoulder 162 of the least one shelf 160, secured therein by the upwardly extending stay 170, to undergo the cleaning operations. If intermediate members 120 are utilized on the conveyor 14, the members are removed from the longitudinal rails 24 of the bed and also placed on the at least one shelf 160 via an insertion of the tip 180 of each shelf into the bore 185 of each member.

Referring again to FIGS. 1, 2, 2B, 7, 7A, 8, 8A and 8B for a further discussion relating to the at least one longitudinal shield 22, the respective pivot means 88a and 88b of the at least one shield preferably comprise a plurality of slots 96a and 96b defined proximal to the lower edges 94a and 94b of the respective shields 22a and 22b, and a respective plurality of lower pins 98a and 98b located on the frame 12, with the slots and lower pins adapted for mating engagement with one another. The slots 96a and 96b, preferably having a substantially vertical orientation in relation to the at least one shield 22 when the shield is in the closed position, are in mating engagement with the respective lower pins 98a and 98b such that each pin projects longitudinally through each respective slot. The elongated shape of the slots allows for both an upwardly and downwardly traversing movement and a rotational movement of the slots about the pins.

The traversing movement allows a given shield of the at least one shield 22, while in a substantially vertical and closed position, to traverse upwardly and downwardly in relation to the frame 12 in securing the shield to the frame (to be discussed further). The rotational movement allows the upper edge of the given shield to rotate outwardly away from the frame 12 about 180 degrees from the substantially vertical and closed position to the fully opened position. When in the fully opened position, the shield is again preferably in a substantially vertical position, but inverted or “upside-down” from the closed position such that the upper edge of the shield is now directed downwardly (i.e. towards the floor) and the inner surface 150 of each shield is directed outwardly. When the shields 22a and 22b of the at least one shield 22 are in their opened positions, they are no longer located laterally of at least the conveyor bed 14, thus allowing a ready exposure of the bed's components and endless belt 19 to steam, hot water, chemical or pressure-wash cleaning processes.

In another embodiment of the invention, the movable attachment of the at least one shield 22 to the frame 12 may also comprise a removable attachment as well to allow for a removal of the at least one shield from the frame during cleaning procedures. To facilitate such a removable attachment, the pins 98a, as illustrated in FIG. 7, are directed in a common direction (in contrast to the pins of FIG. 1 directed in opposite directions) with at least one pin defining an elongated flange 110 thereon, illustrated in FIG. 7A, adapted for positional engagement with the respective slot 96a of the pivot means 88a.

The elongated flange 110, perpendicularly located at the end of the pin 98a, defines a length and width. The length of the flange 110 exceeds the width of the slot 96a while the width of the flange preferably does not exceed that of the pin 98a. The positional engagement of the flange 110 with the slot 96a thus comprises a rotational alignment of the slot with the length of the flange. Thus, when the pin 98a is in mating engagement with the slot 96a such that the pin and flange 110 project longitudinally there-through, a rotational alignment of the slot with the flange will allow for a removal of the slot from about the pin to facilitate a removal of the shield 22a from the frame 12. Conversely, a non-alignment of the slot 96a with the flange 110 while the pin 98a projects there-through will prevent a removal of the slot from about the pin to thus preclude a removal of the shield 22a from the frame.

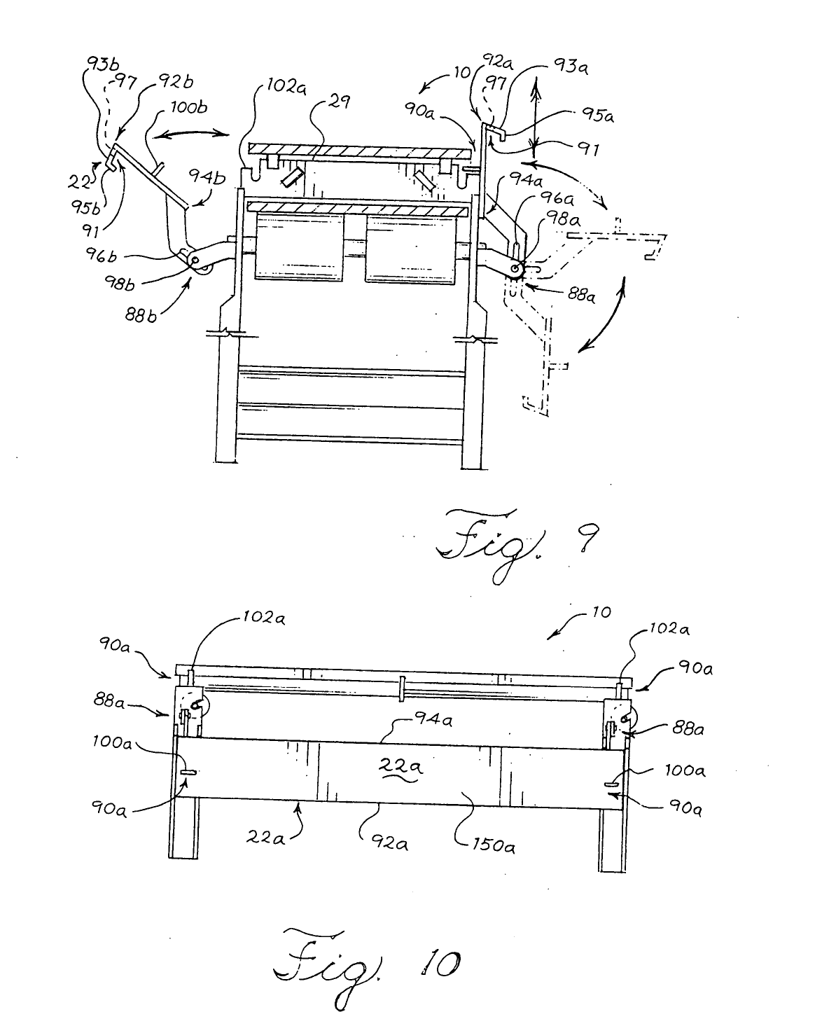

Although the flange 110 may be oriented vertically or horizontally in relation to the pin 98a, in the preferred embodiment, it is oriented on a rotational angle a in relation thereto. The rotational angle a may thus fall within a range of from about 1 deg. to about 89 deg. from vertical, and is preferably about 45 deg. from vertical, as illustrated in FIGS. 7A and 10A. Thus, as the longitudinal shield 22a is rotated outwardly from its closed, vertical position on the frame 12 to the open position, the shield may be removed from the frame when the shield is located at about a 45 degree angle there-from.

Although FIG. 7 illustrates the flange 110 utilized in relation to pins 98a and slots 96a of pivot means 88a, it is understood that the flange is utilized with the pins 98b and slots 96b of pivot means 88b as well (see FIG. 8). Also, although FIG. 7 illustrates the flange 110 associated with only the right pin 98a, it is understood that it may be associated with only the left pin or with both pins as well. Furthermore, while FIG. 7 illustrates pins 98a as directed in a common “right” direction, it is understood that the pins may be directed in a common left direction as well.

The lower pins 98a and 98b are preferably mounted to the legs 16 of the frame. However, it is understood that the lower pins may be located on other components of the frame as well. For example, FIGS. 7 and 8 illustrate an embodiment of the conveyor having the lower pins 98a and 98b mounted to the optional struts 39 (illustrated in phantom) joining the legs 16 located on a common side of the conveyor 10 while FIGS. 4A, 8A, 8B and 8C illustrate embodiments of the conveyor having the lower pins attached to the flanges 49 of the frame. Furthermore, while the figures illustrate two slots per shield for mating engagement with two associated lower pins, it is understood that each shield can have any number of slots for engagement with an equal number of lower pins.

Although the figures illustrate the pivot means 88a and 88b of the conveyor 10 comprising slots 96a and 96b defined proximal to a given lower edge 94a and 94b of the at least one shield 22 (i.e. shields 22a and 22b) and adapted for mating engagement with a plurality of respective lower pins 98a and 98b located on the frame 12, it is understood that the slots may be defined on the frame and the lower pins located proximal to a lower edge of the at least one shield for mating engagement with the slots located on the frame. In this configuration, the pins 98a and 98b of the at least one shield 22 (i.e. shields 22a and 22b) both traverse upwardly and downwardly and rotate within the slots 96a and 96b of the frame 12 to facilitate the opening and closing movements of the at least one shield.

Referring to FIGS. 1, 2, 2B, 7, 8, 8A and 9, the respective securement means 90a and 90b of the at least one shield 22 in one embodiment comprise a plurality of openings 100a and 100b defined proximal to the upper edges 92a and 92b of the respective shields 22a and 22b, and a respective plurality of upper pins 102a and 102b located on the frame 12, with the openings and upper pins adapted for removable mating engagement with one another. The openings 100a and 100b, preferably having a substantially horizontal orientation in relation to the respective shield when the shield is in the closed position, are in removable mating engagement with the respective upper pins 102a and 102b when the respective shields are in the closed positions such that each pin projects upwardly through each respective opening.

Referring respectively to FIGS. 1 and 8A and 9, the upper pins 102a and 102b are preferably mounted to or defined in the cross members 26 or end members 115 of the frame. More preferably, the upper pins are mounted to or defined in the upper surface 29 of a given cross member 26 or end member 115. However, it is understood that the upper pins may be located on other components of the frame as well. For example, FIG. 4A illustrates an embodiment of the frame 12 having upper pins 102a and 102b mounted to or defined in the connectors 135 of the frame 12 while FIG. 6 illustrates an embodiment of the frame having the upper pins mounted to or defined in upper portions of the legs 16. Where the upper pins are mounted to or defined in cross members 26 or end members 115 of the frame 12, it is understood that the upper pins may be located on any cross member or end member of the conveyor 10, regardless of whether or not a given cross member or end member is affixed to a pair of legs 16. Where a given cross member 26 or end member 115 is not affixed to a pair of legs 16, the pivot means 88 of the associated longitudinal shield 22 may be located in relation to the optional strut 39 as shown in phantom in FIGS. 7 and 8. Furthermore, while the figures illustrate two openings per shield for engagement with two associated upper pins, it is understood that the at least one shield can have any number of openings for association with an equal number of upper pins.

Although FIGS. 1, 2, 2B, 7, 8, 8A and 9 illustrate the respective securement means 90a and 90b of the at least one shield 22 comprising a plurality of openings 100a and 100b defined proximal to the upper edges 92a and 92b of the respective shields 22a and 22b and a respective plurality of upper pins 102a and 102b located on the frame 12, it is understood that the plurality of openings 100a and 100b may be defined on the frame 12 while the plurality of upper pins 102a and 102b is located proximal to the upper edges of the shield (i.e., FIGS. 8B and 10A), with the openings and upper pins again adapted for removable mating engagement with one another. As illustrated in FIGS. 8B and 10A, the openings 100a and 100b, preferably having a substantially vertical orientation, are preferably defined in respective connectors 135 of the frame 12. However, it is understood that the openings may be defined at the upper ends of the legs 16 (illustrated in the alternative in FIG. 6) or other components of the frame as well.

Referring to FIGS. 8B and 10A, the respective upper pins 102a and 102b, located at respective upper edges 92a and 92b of shields 22a and 22b, each have a substantially horizontal orientation in relation to the respective shields when the shields are in the closed position. The end 145 of each pin 102a and 102b is downwardly directed, when the respective shield is in the closed position, to removably secure the shield to the openings 100a and 100b of the frame 12. Thus, when the shields 22a and 22b are in their respective closed positions, the pins 102a and 102b are in removable mating engagement with the respective openings 100a and 100b such that each pin projects longitudinally through each respective opening, with the downwardly directed pin ends 145 removably securing the respective shields to the frame 14. While the figures illustrate two openings per shield for engagement with two associated upper pins, it is understood that the at least one shield can have any number of openings for association with an equal number of upper pins.

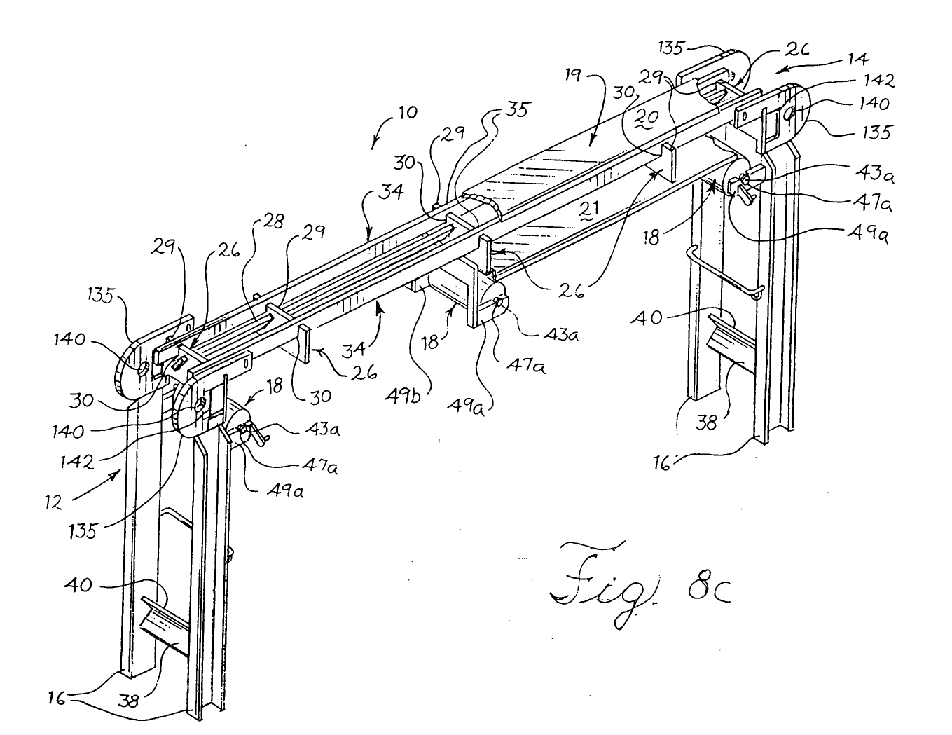

Referring to FIGS. 1, 8A, 8B, 9, 10 and 10A illustrating shields 22a and 22b of the at least one shield 22, the pivot means 88a and 88b of the shields work in association with the respective securement means 90a and 90b to position the shields such that each securement means releasably retains each shield in the closed position to the frame 12. FIGS. 1, 8A, 9 and 10 illustrate embodiments of the conveyor 10 having upper pins 102a and 102b located on cross members 26 or end members 115 of the frame 12 for engagement with respective openings 100a and 100b located on the respective shields 22a and 22b. As illustrated in FIG. 9 showing an operation of this embodiment, in releasably retaining the shields 22a and 22b in their respective closed positions, the upper pins 102a and 102b of the securement means 90a and 90b, located on the frame 12, engage the associated openings 100a and 100b, defined proximal to the respective shield's upper edge 92a or 92b, by protruding upwardly through the openings. When in this engaged position, the weight of the shields 22a or 22b keeps the openings 100a and 100b in respective mating engagement with the upper pins 102a and 102b, thus precluding a rotational movement of the upper edge 92a of each shield away from the frame 12 to prevent a movement of either shield to the opened position.

Referring again to FIG. 9, illustrating shields 22a and 22b of the at least one shield 22, to disengage the openings 100a and 100b from the upper pins 102a and 102b, the shield 22a or 22b is lifted upwardly to lift the respective openings above and off of the associated upper pins. The pivot means 88a or 88b facilitates the upward movement of the shield 22a or 22b by allowing the traversing movement of the slots 96a or 96b about the respective lower pins 98a or 98b. After the openings 100a or 100b of the shield 22a or 22b are lifted above and off the upper pins 102a or 102b, thus releasing either shield from its retained, closed position, the upper edge 92a or 92b of the respective shield is rotated away from the frame 12 about 180 degrees to move the shield to the fully opened position (FIGS. 9 and 10). The pivot means 88a or 88b facilitates the rotational movement of the respective shield 22a or 22b by allowing a rotational movement of the slots 96a or 96b about the respective lower pins 98a or 98b.

FIGS. 8B and 10A illustrates an embodiment of the conveyor 10 having openings 100a and 100b defined in the connectors 135 of the frame 12 for engagement with respective upper pins 102a and 102b located on the respective shields 22a and 22b. As illustrated in FIG. 10A showing an operation of this embodiment, in releasably retaining the shields 22a and 22b in their respective closed positions, the upper pins 102a and 102b of the securement means 90a and 90b, located proximal to the upper edges 92a and 92b of the respective shields 22a and 22b, engage the associated openings 100a and 100b defined on respective connectors 135 of the frame, by protruding longitudinally through the openings. When in this engaged position, the weight of the shields 22a or 22b keeps the downwardly directed ends 145 of the respective upper pins 102a and 102b in respective mating engagement with openings 100a and 100b, thus precluding a rotational movement of the upper edge 92a of each shield away from the frame 12 to prevent a movement of either shield to the opened position.

To disengage the upper pins 102a and 102b from the openings 100a and 100b, the shield 22a or 22b is lifted upwardly to lift the respective downwardly-directed pin ends 145 into longitudinal alignment with the associated openings. The pivot means 88a or 88b facilitates the upward movement of the shield 22a or 22b by allowing the traversing movement of the slots 96a or 96b about the respective lower pins 98a or 98b. After the downwardly-directed ends 145 of the pins 102a and 102b of the shields 22a or 22b are lifted into longitudinal alignment with the openings 100a or 100b, thus releasing either shield from its retained, closed position, the upper edge 92a or 92b of the respective shield is rotated away from the frame 12 about 180 degrees to move the shield to the fully opened position. The pivot means 88a or 88b facilitates the rotational movement of the respective shield 22a or 22b by allowing a rotational movement of the slots 96a or 96b about the respective lower pins 98a or 98b.

As illustrated in FIG. 10 wherein the shield is movably connected to the frame 12, when a given shield of the at least one shield 22 is in the opened position, the engagement of the associated slots with the respective lower pins allows the shield to remain movably attached to the frame 12. In remaining movably attached to the frame 12, the shield is not prone to contamination during cleaning processes that may occur as when the shield is fully removed there-from. Instead, it is cleaned, drained and sanitized while held in a sanitary location. If the shield were fully removable from the frame, cleaning personnel, after moving the shield from the closed position during a given cleaning process, may inadvertently place the shield on the floor or some other surface prone to contamination, thus contaminating the shield. In remaining movably attached to the frame, such inadvertent actions by cleaning personnel are avoided.

If a removal of the shields 22a and 22b from the frame 12 is nonetheless desired, as illustrated in FIGS. 7 and 10A, the shields are both removably and movably connected to the frame 12. A rotational alignment of the slots 96a and 96b with the flanges 110 will allow for a removal of the slots from about the pins 98a and 98b to facilitate a removal of the shields from the frame 12. Conversely, a non-alignment of the slots 96a and 96b with the flanges 110 while the pins 98a and 98b project there-through will prevent a removal of the slots from about the pins to thus preclude a removal of the shields 22a and 22b from the frame 12. Because the preferred rotational angle a of the flange is about 45 degrees from vertical, as the longitudinal shields 22a and 22b are respectively rotated outwardly from their closed positions on the frame 12 to the open positions, the shields may be removed from the frame when they are located at about a 45 degree angle there-from.

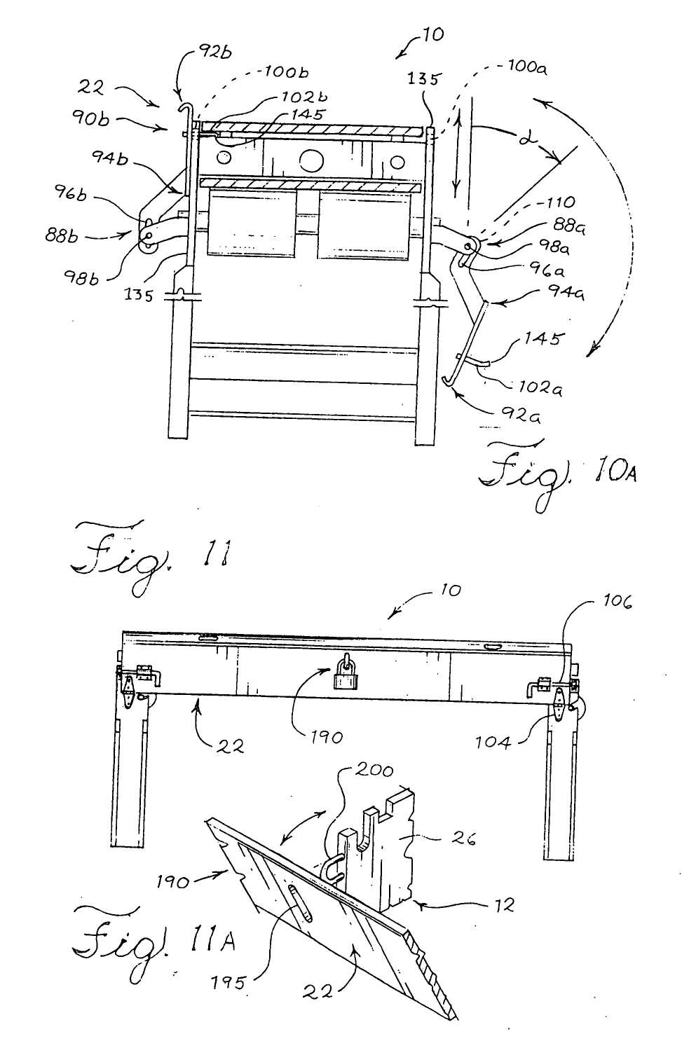

Although, in the preferred embodiment, lower pins and associated slots are used for the respective pivot means of the at least one shield while upper pins and associated openings are used for the respective securement means, it is understood that other embodiments of the pivot and securement means are possible as well. For example, as illustrated in FIG. 11, the pivot means may comprise at least one hinge 104 or other mechanism understood in the art located at the lower edge of the at least one shield and attached to the frame 12, to movably attach the shield to the frame, while each securement means may comprise at least one latch 106 or other mechanism understood in the art located on the shield for engagement with the frame.

It is noted that for the protection of personnel using the conveyor, the at least one shield may further comprise a locking means 190 such that the locking means locks the shield in at least the closed position. In the embodiment illustrated in FIG. 11A, the locking means 190 comprises an opening 195 preferably defined in the at least one shield 22 and an outwardly directed staple 200 connected to the frame 12 of the conveyor, with the opening preferably adapted for mating engagement with the staple. Thus, when the at least one shield is secured in the closed position, the staple 200 protrudes through the shield's opening 195 such that a common padlock may be locked through the staple to lock the at least one shield in the closed position.

Although FIG. 11A illustrates the staple 195 connected to the cross member 26 of the frame 12, it is understood that the staple may be connected to the conveyor's end members 115, longitudinal rails 24, legs 16, connectors 135 or other components as well. Also, although an opening and staple are illustrated in FIG. 11A as the locking means 190 for locking the at least one shield when in at least the closed position, it is understood that any other common locking mechanisms may be utilized as well. For example, the latch 106 may have a bore defined there-through to allow a common padlock to be locked through the latch when securing the at least one shield in the closed position. Furthermore, although the locking means 180 is illustrated in FIG. 11 as used with the at least one shield 22 having a hinge 104 as the pivoting means and the latch 106 as the securement means, it is understood that the locking means may be utilized with any of the conveyor embodiments utilizing any embodiment of pivoting and securement means.

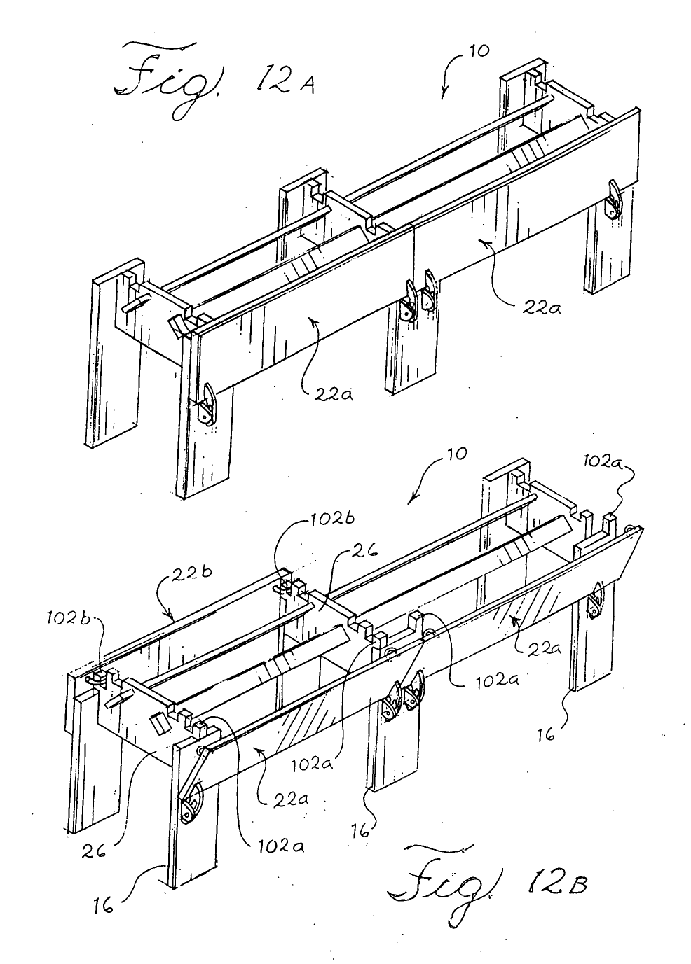

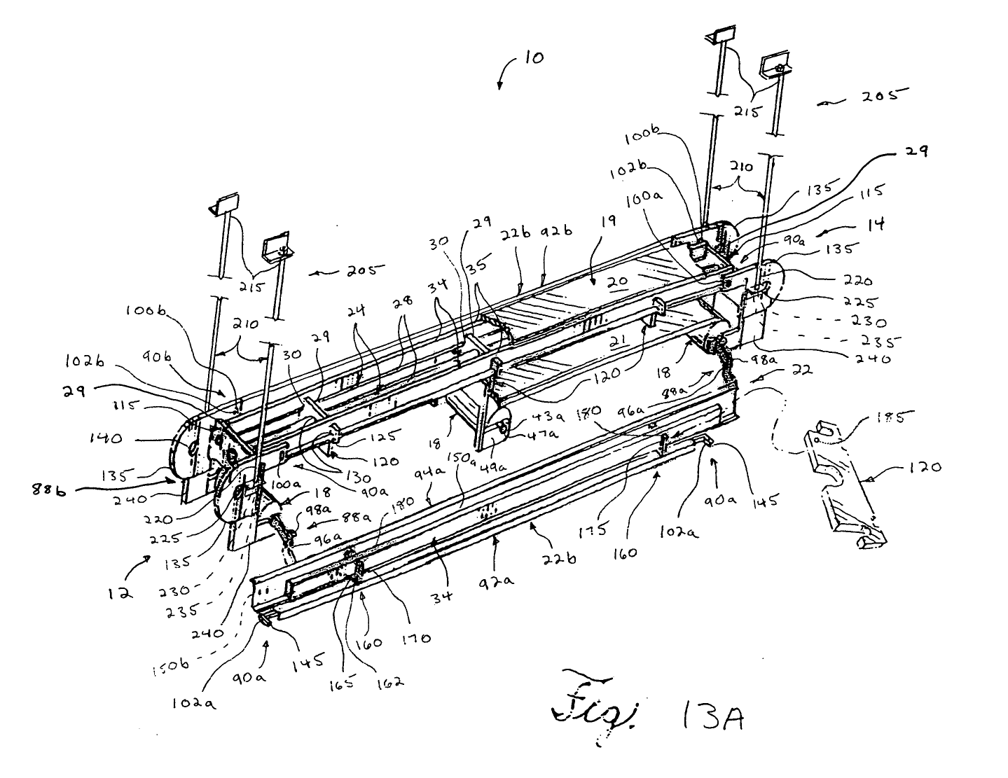

While the foregoing description and figures illustrate the conveyor 10 having longitudinal shields 22a and 22b of the at least one shield located in opposition to one another about the frame 12, it is understood, as illustrated in FIG. 12A, that one shield or multiple shields may be located on a single side of the conveyor as well. For example, one or more shields 22a may be utilized on only a single side of the conveyor when one side of the conveyor is located adjacent to a wall or another piece of equipment, thus preventing physical access by personnel to that side of the conveyor.

It is further understood that, in addition to shields 22a and 22b of the at least one shield 22 illustrated by example in the foregoing figures, multiple shields in various combinations may be located on both sides of the conveyor as well, as illustrated in FIG. 12B. It is noted that in both FIGS. 12A and 12B, the left shield 22a is secured to pins 102a and 102b, located on the cross members 26, while the right shield 22a is secured to pins 102a, located on the legs 16, further evidencing the variations in embodiments of the conveyor. Regardless of the placement or quantity of shields on the conveyor, the opening, closing and securing operations of a given shield via the pivot means and securement means, as well as its location in relation to at least the conveyor bed when in the closed position, would be as described herein.

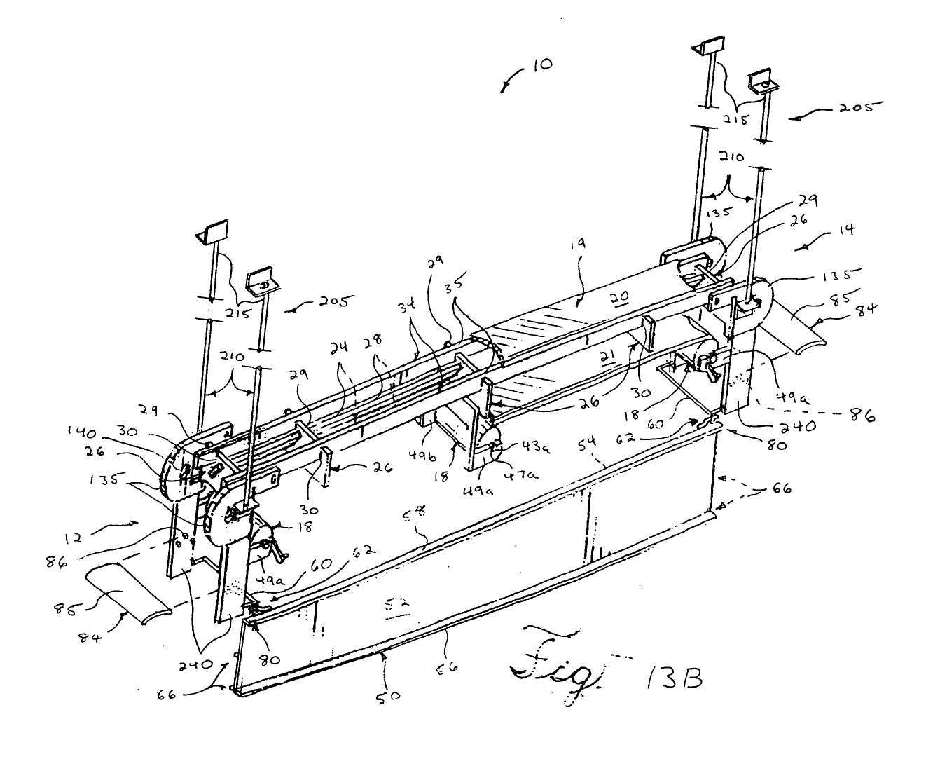

As illustrated in FIGS. 13A and 13B, it is yet further understood that additional embodiments of the conveyor 10 may comprise a frame 12 comprising a conveyor bed 14 supported by a suspension system 205 in place of the plurality of legs 16. Again, at least one rotatable roller 18 is supported by the frame 12, with the least one endless belt 19 in contact with the at least one roller 18 of the conveyor 10. The at least one belt again defines both upper and lower portions 20 and 21, with the upper portion (conveying run) 20 supported by the conveyor bed 14. At least one longitudinal shield 22 is again movably attached to the frame 12 and is movable between at least opened and closed positions, with the at least one longitudinal shield located laterally of at least the conveyor bed 14 when the shield is in the closed position.

The suspension system 205 supporting the conveyor bed 14 preferably comprises a plurality of tension supports 210 defining upper and lower ends 215 and 220. The upper end 215 of each support 210 is preferably connected to an elevated or overhead structure, such as a ceiling, truss, beam, cat-walk or other structure displaced from the ground. The lower end 220 of each support is preferably connected to a common angle 225 preferably attached to each connector 135 of the frame 12, or to a downward extension 240 of the frame preferably connected to and extending downwardly from each connector. Each angle 225 of the frame 12 preferably defines a bore 230 there-through adapted for mating engagement with the lower end 220 of the support. In one embodiment, the lower end 220 of each support 210 is threaded such that the threaded portion extends downwardly through the bore 230 of each angle 225, with the support secured thereto via a nut 235 threaded onto the support end and against an underside of the angle.

However, it is understood that the lower end 220 of each support 210 may have a horizontal bore defined there-through, adapted for mating engagement with a transverse pin located therein and against the underside of the angle 225 of the frame 12. It is also understood that the tension supports 210 may be connected to other components the conveyor 10 as well, with or without utilizing the angles 225. It is further understood that a given tension support 210 may be connected to a given angle 225 or other component via any fastener understood in the art, or via welds or similar bonding methods. Furthermore, although the tension supports 210 comprising the suspension system 205 supporting the conveyor bed 14 preferably comprise rods, it is understood that cables or other supports understood in the art may be utilized as well.

FIGS. 13A and 13B thus illustrates embodiments of the conveyor 10 having the bed 14 supported by the tension supports 210 of the suspension system 205. The conveyor bed 14 illustrated in FIG. 13A again comprises the plurality of longitudinal rails 24 fixably connected to the plurality of end members 115. The bed again further comprises the plurality of intermediate members 120 supporting the plurality of wear strips 34 located substantially between the end members 115, with the longitudinal rails 24 again supporting the intermediate members 120 and having at least a sloped upper surface 28. With regard to the sloped upper surface 28, FIG. 13A illustrates an embodiment of the bed having the three longitudinal rails 24 of round cross section. Again, however, longitudinal 24 rails having any cross-sectional shape may be utilized as well, with such rails defining at least a sloped upper surface 28. Although FIG. 13A illustrates three longitudinal rails 24, it is understood that any number may be utilized, with multiple rails arranged either in parallel or series relation to one another.

The conveyor bed 14 of FIG. 13B, supported by the tension supports 210, again comprises the plurality of longitudinal rails 24 having at least a sloped upper surface 28 and fixably connected to the plurality of cross members 26, with the cross members supporting the plurality of wear strips 34. Again, to enable a sloping of the upper surface 28, the longitudinal rails 24 in one embodiment have a rectangular cross section and are fixably connected to the cross members 26 on a predetermined angle (i.e. between about 5 and about 85 deg., preferably between about 15 and about 45 deg.) such that all of the surfaces of the rectangle are sloped from the horizontal. Although longitudinal rails 24 having a rectangular cross section are utilized in the embodiment illustrated in FIG. 13B, it is understood that rails having other cross sectional shapes may be utilized as well that minimize the presence of horizontal surfaces. Although FIG. 13B illustrates two longitudinal rails 24, it is understood that any number may be utilized, with multiple rails arranged either in parallel or series relation to one another.

With regard to the respective forgoing embodiments of the conveyor bed 14 illustrated in FIGS. 13A and 13B, the cross members 26, end members 115 and intermediate members 120 are again oriented transverse to the conveyor 10 and comprise substantially upright brackets having an upper edge 29. Each member 26, 115 and 120 again has a predetermined maximum thickness to minimize the collection of particulate matter and residues thereon. As respectively illustrated in FIGS. 4, 4B, 13A and 13B, each cross member 26 and intermediate 120 also again includes a plurality of indented seats 30 defined along its upper edge 29 for supporting the plurality of removable wear strips 34, with the seats again adapted to accept an insertion of the wear strips therein. Although removable wear strips 34 are preferred, it is again understood that the wear strips may nonetheless be fixably secured to the respective cross members 26 or intermediate members 120 as well. Each intermediate member 120 also again defines a plurality of recesses 130 along its lower edge 125 adapted for removable engagement with the longitudinal rails 24, with the longitudinal rails thus preferably removably supporting the intermediate members.

Again, with the plurality of respective cross members 26 and intermediate members 120 preferably removably supporting the plurality of wear strips 34, the plurality of wear strips of the conveyor bed 14 again run along the conveyor 10, with each strip having an upper surface 35 that is in contact with the underside of an upper portion 20 of the at least one endless belt 19 and a lower surface that is in contact with and supported by at least a lower surface of the seat. Again, when inserted into a given seat 30 of a respective cross member 26 or intermediate member 120, a given wear strip 34 preferably is removably secured within the seat via a resistance fit between the seat and wear strip. Optional slots 37 may again be defined in the lower surface of each wear strip for engagement with the seats of the cross members 26 or intermediate members 120 as illustrated in FIGS. 4 and 4B, respectively. The upper surface 35 of each wear strip 34 is located upwardly of the upper edge 29 of a given cross, end or intermediate member to ensure that the upper portion 20 of the at least one belt 19 does not contact the respective members.

The at least one rotatable roller 18 is again supported by the frame 12 and in contact with the at least one endless belt 19. Again, one or more rollers of the at least one roller 18 may be rotatably driven by a motor (not shown) or may be non-driven (i.e. idler roller(s)), with any quantity of the at least one roller 18 located on the conveyor 10 as well. Such rollers of the at least one rotatable roller 18, although preferably removably supported by the frame 12, may be fixably supported by the frame as well. With reference to FIG. 5, the at least one roller 18 is again preferably comprised of at least one substantially cylindrical body 42 of solid material rotatably mounted in concentric relation to an axle 43 defining ends 43a and 43b.

At least one pair of receivers 47a and 47b is thus defined within the frame 12 for the at least one roller 18 and is adapted for operable engagement with the opposing ends 43a and 43b of the axle 43. In the embodiment illustrated in FIGS. 13A and 13B, each receiver 47a and 47b of the at least one pair comprises a downwardly-directed, elongated recess defined in each flange 49 of the frame, and adapted for removable, sliding engagement with an axle end. As illustrated therein, each flange 49 is again preferably connected to the longitudinal rails 24 of the conveyor bed 14, or to the downward extensions 240 of the frame 12 preferably connected to the connectors 135 of the frame and extending downwardly there-from.

However, it is understood that the receivers 47a and 47b may be defined in other components of the frame as well. For example, the receivers may be defined in the downward extensions 240 themselves. The axle ends 43a and 43b of the at least one roller 19 may also operably engage the bores 140 defined the paired connectors 135 of the frame. Furthermore, although the at least one roller 18 preferably comprises at least one cylindrical body 42 mounted in concentric relation to an axle 43 defining ends 43a and 43b, it is again understood that the at least one roller may be unitary as well wherein the at least one cylindrical body and the axle defining the two ends are comprised of a single, solid material (i.e. food-grade plastic, aluminum, stainless steel, etc.), with such axle ends rotating within the respective receivers 47a and 47b or bores 140.

As illustrated in FIG. 13A, the movable attachment of the at least one longitudinal shield 22 to the frame 12 again comprises respective pivot means 88a and 88b and respective securement means 90a and 90b. Each pivot means again enables a pivoting and translating movement of a given shield between opened, closed and secured positions on the frame 12 while each securement means again releasably retains the shield in the closed position to the frame. Each shield 22a and 22b again comprises a substantially longitudinal panel having respective upper edges 92a and 92b and lower edges 94a and 94b, and defines respective inner surfaces 150a and 150b, and outer surfaces 155a and 155b. The vertical distance between the upper and lower edges of each shield is predetermined such that a given shield is located laterally of at least the conveyor bed 14 when in the closed position. Each shield may also have an increased vertical distance between its respective upper and lower edges such that a given shield, when in the closed position, is located laterally of both the upper and lower portions (conveying and return runs) 20 and 21 of the at least one endless belt 19, and optionally located laterally of the at least one roller 18 as well.

Thus, when in the closed position, each shield 22a and 22b of the at least one shield 22 is in a substantially vertical position and covers a side of at least the bed 14 and optionally the upper and lower portions 20 and 21 of the at least one endless belt 19 and/or the at least one roller 18 to prevent any interference with these components by personnel using the conveyor, thus preventing possible injury to these personnel. Also when in the closed position, the respective upper edges 92a and 92b of the shields 22a and 22b may again be located upwardly of the upper portion 20 of the at least one belt 19 (supported by the wear strips 34) by a predetermined distance to function as guide-ways that prevent conveyed food products from falling from the outer edges of the belt's upper portion during production operations.

The pivot means 88a and 88b of the at least one shield again preferably comprise a plurality of slots 96a and 96b defined proximal to the lower edges 94a and 94b of the respective shields 22a and 22b, and a respective plurality of lower pins 98a and 98b located on the frame 12, with the slots and lower pins adapted for mating engagement with one another. The slots 96a and 96b, preferably having a substantially vertical orientation in relation to the at least one shield 22 when the shield is in the closed position, are again in mating engagement with the respective lower pins 98a and 98b such that each pin projects longitudinally through each respective slot. The elongated shape of the slots again allows for both an upwardly and downwardly traversing movement and a rotational movement of the slots about the pins. The movable attachment of the at least one shield 22 to the frame 12 may again also comprise a removable attachment as well to allow for a removal of the at least one shield from the frame during cleaning procedures. To facilitate such a removable attachment, the pins 98a and 98b may be directed in a common direction with at least one pin defining an elongated flange 110 thereon (as illustrated in FIGS. 7, 7A and 8) adapted for positional engagement with the respective slot 96a and 96b of the pivot means 88a and 88b.

As illustrated in FIGS. 13A and 13B, the lower pins 98a and 98b are preferably mounted to the flanges 49 of the frame. However, it is understood that the lower pins may be located on other components of the frame as well. For example, the lower pins 98a and 98b may be mounted to the downward extensions 240 preferably connected to the connectors 135 of the frame and extending downwardly there-from. Other embodiments of the conveyor 10 may have the lower pins 98a and 98b mounted to optional struts 39 (not shown) joining the downward extensions 240 located on a common side of the conveyor. Furthermore, while FIG. 13A illustrates two slots per shield for mating engagement with two associated lower pins, it is again understood that each shield can have any number of slots for engagement with an equal number of lower pins. Also, although FIG. 13A illustrates the pivot means 88a and 88b of the conveyor 10 comprising slots 96a and 96b defined proximal to a given lower edge 94a and 94b of the at least one shield 22 (i.e. shields 22a and 22b) and adapted for mating engagement with a plurality of respective lower pins 98a and 98b located on the frame 12, it is again understood that the slots may be defined on the frame and the lower pins located proximal to a lower edge of the at least one shield for mating engagement with the slots located on the frame. In this configuration, the pins 98a and 98b of the at least one shield 22 (i.e. shields 22a and 22b) both traverse upwardly and downwardly and rotate within the slots 96a and 96b of the frame 12 to facilitate the opening and closing movements of the at least one shield.

The securement means 90a and 90b of the at least one shield 22 of FIG. 13A again preferably comprises the plurality of openings 100a and 100b defined on the frame 12 and the plurality of upper pins 102a and 102b located proximal to the upper edges of the shield, with the openings and upper pins again adapted for removable mating engagement with one another. The openings 100a and 100b, preferably having a substantially vertical orientation, are preferably defined in respective connectors 135 of the frame 12. However, it is understood that the openings may be defined in other components of the frame as well. The respective upper pins 102a and 102b, located at respective upper edges 92a and 92b of shields 22a and 22b, each again have a substantially horizontal orientation in relation to the respective shields when the shields are in the closed position. The end 145 of each pin 102a and 102b is again downwardly directed, when the respective shield is in the closed position, to removably secure the shield to the openings 100a and 100b of the frame 12 (as illustrated in FIGURE 10A).

Thus, when the shields 22a and 22b are in their respective closed positions, the pins 102a and 102b are in removable mating engagement with the respective openings 100a and 100b such that each pin projects longitudinally through each respective opening, with the downwardly directed pin ends 145 removably securing the respective shields to the frame 14. While the figures illustrate two openings per shield for engagement with two associated upper pins, it is understood that the at least one shield can have any number of openings for association with an equal number of upper pins. Furthermore, although FIG. 13A illustrates the respective securement means 90a and 90b of the at least one shield 22 comprising a plurality of openings 100a and 100b defined on the frame 12 and a respective plurality of upper pins 102a and 102b located proximal to the upper edges of the respective shields 22a and 22b, it is understood that the plurality of openings 100a and 100b may be defined proximal to the upper edges 92a and 92b of the respective shields 22a and 22b and the respective plurality of upper pins 102a and 102b located on the frame 12 (i.e., mounted to or defined in the connectors 135 of FIG. 4A), with the openings and upper pins again adapted for removable mating engagement with one another (as illustrated in FIG. 9).

At least one shelf 160 may again be defined on the at least one movable shield 22 for removably supporting at least one of the removable wear strips 34, and optionally at least one of the intermediate members 120, during cleaning operations. Again, it is understood that the at least one shelf 160 may be defined on only one shield of the at least one shield 22, or on any number of shields if more than one shield is present on the conveyor 10. The at least one shelf 160 is again preferably defined on the inner surface 150 of a given shield 22 (illustrated by example on inner surface 150a of the shield 22a), preferably proximal to the shield's lower edge 94b, such that the shelf is readily accessible when the shield is in the opened position, as shown. Although two shelves 160 are illustrated by way of example in FIG. 13A, it is understood that fewer or additional shelves may be utilized as well, preferably in relation to the number of intermediate members utilized on the conveyor 10 (to be further discussed).

Each shelf 160 again comprises a shoulder 162 oriented preferably perpendicular to the inside surface 150b of the at least one shield 22b and defining a resting surface 165 adapted to support one or more of the removable wear strips 34 of the conveyor bed 14. The resting surface 165 is of a length sufficient to support one, two or any number of wear strips resting thereon (only one wear strip 34 illustrated in FIG. 13A for clarity), with multiple wears strips arranged either laterally of one another or on top of one another. Each shelf 160 again further comprises a stay 170 located at an end of the resting surface 165, outwardly of the shield's inner surface 94b. The stay 170 extends upwardly from the resting surface 165 to define an inner securing surface 175 adapted to secure the one or more wear strips 34 on the shelf 160 to prevent them from falling outwardly from the shoulder 162.

The upwardly extending stay 170 of the at least one shelf 160 again terminates at a tip 180 adapted for insertion into a bore 185 optionally defined in each of the removable intermediate members 120. Thus, for embodiments of the conveyor utilizing the removable intermediate members 120, the insertion of the tip 180 of the stay 170 into the bore 185 of a given intermediate member allows the shelf 160 to removably support the member during cleaning operations. Again, to ensure that each intermediate member 120 of the conveyor's bed 14 is supported by a shelf 160 during such cleaning operations, the number of shelves located on a given conveyor is preferably at least equal to the number of intermediate members utilized.

Again, although the embodiment of FIG. 13A utilizes lower pins and associated slots for the respective pivot means and upper pins and associated openings for the respective securement means, it is understood that other embodiments of the pivot and securement means are possible. The pivot means may thus again comprise at least one hinge 104 or other mechanism understood in the art located at the lower edge of the at least one shield and attached to the frame 12, to movably attach the shield to the frame, while the securement means may again comprise at least one latch 106 or other mechanism understood in the art located on the shield for engagement with the frame (FIG. 11). Again, for the protection of personnel using the conveyor, the at least one shield may further comprise a locking means 190 such that the locking means locks the shield in at least the closed position, thus utilizing the embodiment of the locking means illustrated in FIG. 11A or any other locking means understood in the art. Furthermore, it is also understood that any number of the at least one longitudinal shield 22 may be utilized on the conveyor 10 in any combination, as illustrated in FIGS. 12A and 12B.

FIG. 13B, having the at least one longitudinal shield 22 omitted for clarity, illustrates the at least one catch pan 50 again optionally utilized with the conveyor 10. The at least one catch pan 50, illustrated by example in FIG. 13B in the “sanitize” position and again having upper and lower surfaces 52 and 54 and leading and trailing edges 56 and 58, is again removably supported by the frame 12 of the conveyor 10 below the lower portion or return run 21 of the at least one endless belt 19. In the preferred embodiment of the invention, the at least one catch pan 50 is removably supported by at least two supports 60 fixably attached to the frame 12, with the at least two supports preferably engaging the lower surface 54 of the pan to allow a sliding movement of the pan in relation to the frame 12. However, instead of having supports 60 (i.e., substantially horizontal rods) extending from respective pairs of legs 16 for engaging the lower surface 54 of the pan, the supports instead extend from respective pairs of the downward extensions 240 of the frame 12, with each extension preferably connected to a connector 135 of the frame and extending downwardly there-from.

A retaining means 62 operably engages the supports 60 to retain the at least one pan in a substantially horizontal orientation while located in a plurality of positions on the frame 12 (i.e., fingers 64 as illustrated in FIG. 6). Optionally, an adjustment means 66 operably engages the supports 60 to define a plurality of positional relationships between the at least one pan and the frame 12 (i.e., stops 68 as illustrated in FIG. 6). An engagement means 80 (i.e., hooks 82 as illustrated in FIGS. 6A and 6B) may operably engage the supports 60 to removably engage the at least one pan 50 to the frame 12 in a non-horizontal position (FIG. 6A), or may be attached to the supports 60 of the frame 12 and adapted for engagement with the retaining means 62, again to removably engage the at least one pan 50 to the frame in the non-horizontal position (FIG. 6B). The at least one pan is thus movable between at least “catch,” “pre-cleaning” and “sanitize” positions. Although FIG. 13B illustrates only one pan of the at least one pan, it is understood that multiple pans may be utilized, as illustrated in FIGS. 2A, 3 and 4C.

At least one hood 84 may be removably located between the paired downwardly directed extensions 240, below the associated cross member 26 or end member 115. Each hood 84 is again removably located on at least a plurality of rests 86 that protrude inwardly from each extension 240 of the associated pair such that a given hood may be readily removed from the frame 12 during cleaning operations. Again, each hood 84 is preferably located upwardly of the support 60 of the frame 12 and has at least a sloped upper surface 85 that overlaps the at least one catch pan 50 to deflect any particulate matter or drips onto the pan that may fall between extension pairs from the endless belt 19.

With regard to the foregoing components of the conveyor 10 utilizing a suspension system 205, it is noted that their operation and function, where applicable, is as described for embodiments of the conveyor utilizing a plurality of legs 16. Also, regardless of embodiment, all of the components of the frame 12, to include the longitudinal rails 24, cross members 26, end members 115, legs 16, leg braces 38, optional struts 39, tension supports 210, at least one catch pan 50, supports 60, retaining means 62, adjustment means 66, engagement means 80, hoods 84 and hood rests 86, as well as the longitudinal shields 22a and 22b and their respective pivot means (88a and 88b) and securement means (90a and 90b), as well as the respective shelves 160, are preferably comprised of stainless steel. Stainless steel is the preferred material of choice for these components because of its inherent resistance to corrosion from the presence of moisture and cleaning agents. While stainless steel is the preferred material of choice, it is understood that other corrosion-resistant materials may be utilized as well, to include aluminum, various alloys, or composite materials.

It also is noted that all of the components of the frame 12, to include the longitudinal rails 24, cross members 26, end members 115, legs 16, leg braces 38, optional struts 39, tension supports 210, at least one catch pan 50, supports 60, retaining means 62, adjustment means 66, engagement means 80, hoods 84 and hood rests 86, as well as the longitudinal shields 22a and 22b and their respective pivot means (88a and 88b) and securement means (90a and 90b), as well as the respective shelves 160, preferably have a solid cross section. A solid cross section for these components reduces sanitation problems present with components having a hollow cross section. Although components of solid cross section are preferred, the components may nonetheless have a hollow cross section (i.e. where necessary as a cost or weight-saving measure).

It is further noted that in the preferred embodiment of the invention, all of the components of the frame 12, i.e. the longitudinal rails 24, cross members 26, end members 115, legs 16, leg braces 38, optional struts 39 and hood rests 86, as well as the pivot means and securement means in relation to the frame and at least one shield 22, to include the at least one shelf 160, and the retaining, adjustment and engagement means in relation to the frame and at least one catch pan 50, are preferably securably attached to one another with continuous welds of a quality that are cleanable, sanitizable, and resist the harboring of contaminants. A use of fasteners such as screws, bolts, nuts and washers to attach these components to one another is undesirable because such fasters establish areas where particulate matter and/or residues from conveyed food products may collect, thus making the areas prone to contamination. The frame 12 and related components thus preferably utilizes a welded unitary construction to eliminate such contamination-prone areas. However, it is understood that common fasteners, although undesirable, may nonetheless be used to attach or fasten any of the conveyor's components to one another.

While the foregoing embodiments of the conveyor have been described particularly for use with food products in a sanitary environment, it is evident that the conveyor could be used with a variety of products and in a variety of environments where the foregoing features of the conveyor are desirable. As such, the claimed conveyor is capable of broad application and is readily adaptable to other fields and uses. Furthermore, while this foregoing description and accompanying drawings are illustrative of the present invention, other variations in structure and method are possible without departing from the invention's spirit and scope.

We claim:

1. A conveyor comprising:
a frame comprising a conveyor bed supported by a plurality of legs;
at least one rotatable roller supported by the frame;
at least one endless belt in contact with the at least one roller, the at least one belt defining an upper portion and a lower portion, the upper portion supported by the conveyor bed; and
at least one longitudinal shield movably attached to the frame and movable between at least opened and closed positions, the at least one shield located laterally of at least the conveyor bed when the shield is in the closed position.

2. The conveyor of claim 1 wherein the conveyor bed comprises a plurality of longitudinal rails having at least a sloped upper surface and fixably connected to a plurality of cross members, the cross members supporting a plurality of wear strips.

3. The conveyor of claim 2 wherein the wear strips of the plurality are removable.

4. The conveyor of claim 2 wherein each cross member of the plurality is oriented transverse to the conveyor and has an upper edge defining a plurality of seats, the wear strips removably secured within the seats.

5. The conveyor of claim 2 wherein the longitudinal rails have a rectangular cross section and are connected to the cross members on an angle such that all surfaces of the rectangle are sloped from the horizontal.

6. The conveyor of claim 1 wherein the conveyor bed comprises a plurality of longitudinal rails fixably connected to a plurality of end members and further comprising a plurality of intermediate members supporting a plurality of wear strips located substantially between the end members, the longitudinal rails removably supporting the intermediate members and having at least a sloped upper surface.

7. The conveyor of claim 6 wherein the wear strips of the plurality are removable.

8. The conveyor of claim 6 wherein each end member of the plurality and each intermediate member of the plurality is oriented transverse to the conveyor, each intermediate member having an upper edge defining a plurality of seats, the wear strips removably secured within the seats.

9. The conveyor of claim 6 wherein the longitudinal rails have a round cross section to define the sloped upper surface.

10. The conveyor of claim 1 wherein the movable attachment the at least one longitudinal shield to the frame comprises a pivot means and a securement means, the pivot means comprising at least one hinge located at a lower edge of the shield and attached to the frame, the securement means comprising at least one latch located on the panel for engagement with the frame.

11. The conveyor of claim 1 wherein the movable attachment the at least one longitudinal shield to the frame comprises a pivot means and a securement means, the pivot means enabling a pivoting and translating movement of the shield between opened, closed and secured positions on the frame and the securement means releasably retaining the shield in the closed position to the frame.

12. The conveyor of claim 11 1wherein the at least one longitudinal shield further comprises a locking means for locking the shield in at least the closed position.

13. The conveyor of claim 11 wherein the at least one shield is removable.

14. The conveyor of claim 11 wherein the at least one shield defines inner and outer surfaces, the inner surface of the at least one shield defining at least one shelf thereon for removably supporting at least one removable wear strip.

15. The conveyor of claim 14 wherein the at least one shelf defines a stay for removably supporting at least one intermediate member.

16. The conveyor of claim 11 wherein the at least one shield comprises a panel having upper and lower edges, the at least one shield defining a plurality of slots proximal to the lower edge and a plurality of openings proximal to the upper edge, the slots adapted for mating engagement with a plurality of lower pins located on the frame and the openings adapted for removable mating engagement with a plurality of upper pins located on the frame, the lower pins and slots comprising the pivot means and the upper pins and openings comprising the securement means.

17. The conveyor of claim 11 wherein the at least one shield comprises a panel having upper and lower edges and the frame defines a plurality of openings, the at least one shield defining a plurality of slots proximal to the lower edge and having a plurality of upper pins located proximal to the upper edge, the slots adapted for mating engagement with a plurality of lower pins located on the frame and the upper pins adapted for removable mating engagement with the plurality of openings, the lower pins and slots comprising the pivot means and the upper pins and openings comprising the securement means.

18. The conveyor of claim 1 further comprising at least one catch pan removably supported by the frame below the lower portion of the at least one belt.

19. The conveyor of claim 18 wherein the at least one catch pan is removably supported by at least two supports fixably attached to the frame, the at least two supports engaging a lower surface of the at least one pan to allow a sliding movement of the pan in relation to the frame.

20. The conveyor of claim 19 further comprising a retaining means operably engaging the supports to retain the at least one pan in a substantially horizontal orientation while located in a plurality of positions on the frame.

21. The conveyor of claim 20 further comprising an adjustment means operably engaging the supports to define a plurality of positional relationships between the at least one pan and the frame.

22. The conveyor of claim 19 further comprising an engagement means operably engaging the supports to removably engage the at least one pan to the frame in a non-horizontal position.

23. The conveyor of claim 20 further comprising an engagement means attached to the supports of the frame and adapted for engagement with the retaining means to removably engage the at least one pan to the frame in a non-horizontal position.

24. A conveyor comprising:
a frame comprising a conveyor bed supported by a plurality of legs, the conveyor bed comprising a plurality of longitudinal rails fixably connected to a plurality of end members and further comprising a plurality of intermediate members removably supporting a plurality of wear strips located substantially between the end members, the longitudinal rails removably supporting the intermediate members and having at least a sloped upper surface;
at least one rotatable roller supported by the frame;
at least one endless belt in contact with the at least one roller and having upper and lower portions, the upper portion supported by the plurality of wear strips;
at least one longitudinal shield movably attached to the frame and movable between at least opened and closed positions, the at least one shield located laterally of at least the conveyor bed and having an upper edge located upwardly of the upper portion of the at least one belt when the shield is in the closed position; and
at least one catch pan removably supported by the frame below the lower portion of the at least one belt, the at least one catch pan movable between at least catch, pre-cleaning and sanitize positions.

25. A conveyor comprising:
a frame comprising a conveyor bed supported by a plurality of legs, the conveyor bed comprising a plurality of longitudinal rails fixably connected to a plurality of end members and further comprising a plurality of intermediate members removably supporting a plurality of wear strips located substantially between the end members, the longitudinal rails removably supporting the intermediate members and having at least a sloped upper surface;
at least one rotatable roller supported by the frame;
at least one endless belt in contact with the at least one roller, the at least one belt defining an upper portion and a lower portion, the upper portion supported by the conveyor bed;
at least one longitudinal shield movably attached to the frame and movable between at least opened and closed positions, the at least one shield located laterally of at least the conveyor bed when the shield is in the closed position, the at least one shield comprising a panel having upper and lower edges and the frame defining a plurality of openings, the shield defining a plurality of slots proximal to the lower edge and having a plurality of upper pins located proximal to the upper edge, the slots adapted for mating engagement with a plurality of lower pins located on the frame and the upper pins adapted for removable mating engagement with the plurality of openings; and
at least one catch pan removably supported by the frame below the lower portion of the at least one belt.

26. The conveyor of claim 25 wherein the wherein the at least one catch pan is removably supported by at least two supports fixably attached to the frame, the at least two supports engaging a lower surface of the at least one pan to allow a sliding movement of the pan in relation to the frame, the conveyor further comprising a retaining means operably engaging the supports to retain the at least one pan in a substantially horizontal orientation while located in a plurality of positions on the frame, an adjustment means operably engaging the supports to define a plurality of positional relationships between the at least one pan and the frame, and an engagement means attached to the supports of the frame and adapted for engagement with the retaining means to removably engage the at least one pan to the frame in a non-horizontal position.

27. A conveyor comprising:
a frame comprising a conveyor bed supported by a suspension system;
at least one rotatable roller supported by the frame;
at least one endless belt in contact with the at least one roller, the at least one belt defining an upper portion and a lower portion, the upper portion supported by the conveyor bed; and
at least one longitudinal shield movably attached to the frame and movable between at least opened and closed positions, the at least one shield located laterally of at least the conveyor bed when the shield is in the closed position.

28. The conveyor of claim 27 wherein the conveyor bed comprises a plurality of longitudinal rails having at least a sloped upper surface and fixably connected to a plurality of cross members, the cross members supporting a plurality of wear strips.

29. The conveyor of claim 28 wherein the wear strips of the plurality are removable.

30. The conveyor of claim 28 wherein each cross member of the plurality is oriented transverse to the conveyor and has an upper edge defining a plurality of seats, the wear strips removably secured within the seats.

31. The conveyor of claim 28 wherein the longitudinal rails have a rectangular cross section and are connected to the cross members on an angle such that all surfaces of the rectangle are sloped from the horizontal.

32. The conveyor of claim 27 wherein the conveyor bed comprises a plurality of longitudinal rails fixably connected to a plurality of end members and further comprising a plurality of intermediate members supporting a plurality of wear strips located substantially between the end members, the longitudinal rails removably supporting the intermediate members and having at least a sloped upper surface.

33. The conveyor of claim 32 wherein the wear strips of the plurality are removable.

34. The conveyor of claim 32 wherein each end member of the plurality and each intermediate member of the plurality is oriented transverse to the conveyor, each intermediate member having an upper edge defining a plurality of seats, the wear strips removably secured within the seats.

35. The conveyor of claim 32 wherein the longitudinal rails have a round cross section to define the sloped upper surface.

36. The conveyor of claim 27 wherein the movable attachment the at least one longitudinal shield to the frame comprises a pivot means and a securement means, the pivot means comprising at least one hinge located at a lower edge of the shield and attached to the frame, the securement means comprising at least one latch located on the panel for engagement with the frame.

37. The conveyor of claim 27 wherein the movable attachment the at least one longitudinal shield to the frame comprises a pivot means and a securement means, the pivot means enabling a pivoting and translating movement of the shield between opened, closed and secured positions on the frame and the securement means releasably retaining the shield in the closed position to the frame.

38. The conveyor of claim 37 wherein the at least one longitudinal shield further comprises a locking means for locking the shield in at least the closed position.

39. The conveyor of claim 37 wherein the at least one shield is removable.

40. The conveyor of claim 37 wherein the at least one shield defines inner and outer surfaces, the inner surface of the at least one shield defining at least one shelf thereon for removably supporting at least one removable wear strip.

41. The conveyor of claim 40 wherein the at least one shelf defines a stay for removably supporting at least one intermediate member.

42. The conveyor of claim 37 wherein the at least one shield comprises a panel having upper and lower edges, the at least one shield defining a plurality of slots proximal to the lower edge and a plurality of openings proximal to the upper edge, the slots adapted for mating engagement with a plurality of lower pins located on the frame and the openings adapted for removable mating engagement with a plurality of upper pins located on the frame, the lower pins and slots comprising the pivot means and the upper pins and openings comprising the securement means.

43. The conveyor of claim 37 wherein the at least one shield comprises a panel having upper and lower edges and the frame defines a plurality of openings, the at least one shield defining a plurality of slots proximal to the lower edge and having a plurality of upper pins located proximal to the upper edge, the slots adapted for mating engagement with a plurality of lower pins located on the frame and the upper pins adapted for removable mating engagement with the plurality of openings, the lower pins and slots comprising the pivot means and the upper pins and openings comprising the securement means.

44. The conveyor of claim 27 further comprising at least one catch pan removably supported by the frame below the lower portion of the at least one belt.

45. The conveyor of claim 44 wherein the at least one catch pan is removably supported by at least two supports fixably attached to the frame, the at least two supports engaging a lower surface of the at least one pan to allow a sliding movement of the pan in relation to the frame.

46. The conveyor of claim 45 further comprising a retaining means operably engaging the supports to retain the at least one pan in a substantially horizontal orientation while located in a plurality of positions on the frame.

47. The conveyor of claim 46 further comprising an adjustment means operably engaging the supports to define a plurality of positional relationships between the at least one pan and the frame.

48. The conveyor of claim 45 further comprising an engagement means operably engaging the supports to removably engage the at least one pan to the frame in a non-horizontal position.

49. The conveyor of claim 46 further comprising an engagement means attached to the supports of the frame and adapted for engagement with the retaining means to removably engage the at least one pan to the frame in a non-horizontal position.

50. A conveyor comprising:
a frame comprising a conveyor bed supported by a suspension system, the conveyor bed comprising a plurality of longitudinal rails fixably connected to a plurality of end members and further comprising a plurality of intermediate members removably supporting a plurality of wear strips located substantially between the end members, the longitudinal rails removably supporting the intermediate members and having at least a sloped upper surface;
at least one rotatable roller supported by the frame;
at least one endless belt in contact with the at least one roller and having upper and lower portions, the upper portion supported by the plurality of wear strips;
at least one longitudinal shield movably attached to the frame and movable between at least opened and closed positions, the at least one shield located laterally of at least the conveyor bed and having an upper edge located upwardly of the upper portion of the at least one belt when the shield is in the closed position; and
at least one catch pan removably supported by the frame below the lower portion of the at least one belt, the at least one catch pan movable between at least catch, pre-cleaning and sanitize positions.

51. A conveyor comprising:
a frame comprising a conveyor bed supported by a plurality of tension supports connected to an elevated structure, the conveyor bed comprising a plurality of longitudinal rails fixably connected to a plurality of end members and further comprising a plurality of intermediate members removably supporting a plurality of wear strips located substantially between the end members, the longitudinal rails removably supporting the intermediate members and having at least a sloped upper surface;
at least one rotatable roller supported by the frame;
at least one endless belt in contact with the at least one roller, the at least one belt defining an upper portion and a lower portion, the upper portion supported by the conveyor bed;
at least one longitudinal shield movably attached to the frame and movable between at least opened and closed positions, the at least one shield located laterally of at least the conveyor bed when the shield is in the closed position, the at least one shield comprising a panel having upper and lower edges and the frame defining a plurality of openings, the shield defining a plurality of slots proximal to the lower edge and having a plurality of upper pins located proximal to the upper edge, the slots adapted for mating engagement with a plurality of lower pins located on the frame and the upper pins adapted for removable mating engagement with the plurality of openings; and
at least one catch pan removably supported by the frame below the lower portion of the at least one belt.

52. The conveyor of claim 51 wherein the wherein the at least one catch pan is removably supported by at least two supports fixably attached to the frame, the at least two supports engaging a lower surface of the at least one pan to allow a sliding movement of the pan in relation to the frame, the conveyor further comprising a retaining means operably engaging the supports to retain the at least one pan in a substantially horizontal orientation while located in a plurality of positions on the frame, an adjustment means operably engaging the supports to define a plurality of positional relationships between the at least one pan and the frame, and an engagement means attached to the supports of the frame and adapted for engagement with the retaining means to removably engage the at least one pan to the frame in a non-horizontal position.
